(19) United States
(12) Patent Application Publication
(10) Pub. No.: US 2013/0222386 A1
(43) Pub. Date: Aug. 29, 2013

(54) IMAGE PROCESSING FOR PROJECTION ON A PROJECTION SCREEN

(71) Applicant: Cannon Kabushiki Kaisha, (US)

(72) Inventors: FALK TANNHÄUSER, RENNES (FR); PASCAL ROUSSEAU, RENNES (FR)

(73) Assignee: CANON KABUSHIKI KAISHA, Tokyo (JP)

(21) Appl. No.: 13/772,140

(22) Filed: Feb. 20, 2013

(30) Foreign Application Priority Data
Feb. 23, 2012 (GB) 1203171.2
Feb. 19, 2013 (GB) 1302874.1

(51) Int. Cl. G06T 11/60; G06T 11/00

(52) U.S. Cl. CPC G06T 11/60; G06T 11/00
USPC 345/428; 345/619

(57) ABSTRACT

A method of processing an original image for projection on a projection screen by a projector, comprising performing pixel interpolation between pixels of a first image associated with the original image and pixels of a second image associated with a pixel grid of the projector, wherein at least one of the first image and the second image has a pixel resolution greater than the resolution of, respectively, the original image and the pixel grid.

Embodiments of the invention provide pixelization artifacts reduction in displaying high-definition videos with flexibility and low complexity.

This application claims the benefit of GB Patent Application No. 1203171.2, filed Feb. 23, 2012, and GB Patent Application No. 1302874.1, filed Feb. 19, 2013, which are hereby incorporated by reference herein in their entirety.

The present invention relates to the displaying of images on a projection screen using a video projection system. The video projection system may comprise a group of aggregated video projection apparatuses (projectors).

Displaying images using a video projection system may consist in using several video projectors, each one projecting a portion of the images of the video on a projection screen. The image portions may slightly overlap and form the overall image on the screen.

Each video projector of the system projects an image (or portion of image) with a given definition and given dimensions. The dimensions are determined by the projector lens focal length, the size of the projector's light modulation device (e.g. an LCD panel) and the distance between the projector and the screen on which the image is projected.

Since the brightness decreases with the square of the distance, increasing the projection distance makes a larger, but also a darker image. Covering a very large projection screen with proper definition and brightness usually requires using several video projectors projecting several portions of the image so that the portions cover adjacent and partially overlapping zones of the overall screen area.

In the overlapping zones, blending may be performed in order to ensure a smooth transition between adjacent portions of image projected by the projectors, even if small displacements are introduced, e.g., by vibrations or thermal expansion of the projectors or their mountings. Blending may consist in continuously decreasing the brightness of the portion of image generated by one projector when approaching the edges of the zone covered by the projector and complementarily increasing the brightness of an adjacent portion of image projected by the adjacent projector in order to obtain a uniform brightness after superimposition of the edges of the two adjacent portions of image in the overlapping zone.

In a projection system, the optical axis of the projectors may not be perpendicular to the projection screen. This may be due to installation constraints such as ceiling mounting or mounting close to lateral walls.

The non-perpendicular configuration of the optical axis may generate distortion, commonly referred to as “homographic distortion”. With such distortion, parallel lines in the original image (that is intended to be projected and for example, that should be reproduced on the projecting screen by aggregation of projected image portions) are generally not displayed as parallel lines in the image projected on the projection screen. Hence, a rectangle in the original image may appear as a trapezoid or any other irregular quadrilateral. Furthermore, small mechanical looseness in the mounting of the projectors may create shifting and rotation of the image that may be perceptible by viewers.

A curved projection screen may also be a source of perceptible distortions. Such a curved projection screen may have a non-planar shape such as a cylinder, a sphere or a dome.

The sources of distortion given above exist for single-projector systems and exist even more for multi-projector systems. Indeed, a distortion generated by a projector projecting a portion of the image may break the continuity of the overall image constituted by the aggregation of all the portions of image projected by the projectors of the system.

In known video projectors, the image projected on the screen may be vertically and/or horizontally shifted while maintaining the projector's optical axis perpendicular to the screen by the means of lens shift. Keystone distortion may be thereby avoided. However, this solution requires a lens covering an image zone larger than necessary for displaying the image. Therefore, the lens has a large diameter, contains a large amount of glass and aberrations and “vignetting” may be difficult to correct. Also, the mechanical or electromechanical means included in the projection system for shifting the lens increase the overall cost of the system. Furthermore, it may appear difficult to rely on lens shifting only for perfectly aligning image potions projected by projectors in a multi-projector system. A supplemental digital image correction of residual distortions may still be needed.

Geometric distortion correction, commonly referred to as “keystone correction”, may consist in digitally applying to the image to be displayed a geometric distortion inverse to the geometric distortion optically introduced by the projection. Thus, “inverse” distortion is applied to the image by data processing. The “inversely” distorted image is then projected and “physical” distortion is applied to the image. The “inverse” distortion and the “physical” distortion mutually cancel their effects and the image eventually projected conforms with the original image to be displayed.

Keystone correction comprises an interpolation process because in general the coordinates of the projector's pixels, expressed in the coordinate system of the desired target image, are not integers. Consequently, the mapping of pixel colours from the input image to the projector pixels, in order to reproduce the input image on the screen with highest possible fidelity, may be a complex process.

Several interpolation methods with specific cost-benefit trade-offs exist, in particular:
Nearest-neighbour interpolation: Each output pixel is assigned the colour of the input pixel being the nearest-neighbour of it. Nearest-neighbour interpolation may be less complex to implement than other techniques but may give unsatisfactory results. Pixel artifacts may be generated.
Bi-cubic interpolation: Each output pixel is assigned a colour determined as a weighted mean of the colours of the sixteen surrounding input pixels. The resulting interpolation function is composed of different bi-cubic polynomials in a continuous and smooth (differentiable) manner. This method may provide good visual results, but it may be more complex and thus costly to implement (in particular for real-time HD video).
Bi-linear interpolation: Each output pixel is assigned a colour determined as a weighted mean of the colours of the four surrounding input pixels. The resulting interpolation function is composed of different bi-linear polynomials in a continuous manner. This is an intermediate solution between nearest-neighbour and bi-cubic interpolations both in terms of cost and in terms of visual result.

Before projection on the projection screen, the resolution of the portions of the original image to be displayed may be increased (or “upscaled”) by an upscale factor which may be high, in particular for HD videos. Such HD videos (for example 1080p or 4k2k videos with 30 or 60 frames per second) require sustaining high data rates and low latency in image processing.

For example, for a three by three (3×3) configuration, with 1080p projectors, the resolution of the aggregated projected portions of image, taking into account image overlapping, is roughly 5000×2500 pixels. The upscale factor from a 1920×1080 pixels input video format (corresponding to 1080p) is about 2.5. In such case, nearest-neighbour (or even bi-linear) interpolation may not provide an acceptable image quality.

Documents U.S. Pat. No. 7,679,690, U.S. Pat. No. 7,855,753 and US 2003/0025837 disclose a module for correcting geometric distortion in a fixed pixel raster projector. A receiver collects a grid of input pixels representing an input image. The correction module generates an output pixel grid representing an output image that compensates for the geometry of the projection surface by repositioning image data interpolated from at least two input pixels. The output image represents an altered input image that, when projected on the projection surface, displays a correctly proportioned input image. The similarity to our solution consists in that geometric distortion correction (both “keystone”/trapezoidal and non-linear correction for curved screens) is provided together with resampling. However, the system according to these documents does not provide enough flexibility for the choice of the scale factor, since only bi-linear interpolation is supported. According to the documents, the bi-linear sampling selected limits the quality of the re-sampled image if an upscale or a downscale by a factor greater than 2 is performed.

Document U.S. Pat. No. 7,941,001 discloses a multi-purpose “scaler” (or sample rate converter) with a vertical scaler module and a “moveable” horizontal scaler module for resampling a video signal either vertically or horizontally according to a selected scaling ratio. The moveable horizontal scaler module is placed in one of two slots within the multi-purpose scaler architecture to provide either horizontal reduction or horizontal expansion as desired. The multi-purpose scaler is arranged to scale the video using non-linear “3 zone” scaling in both the vertical and horizontal direction when selected. The multi-purpose scaler is arranged to provide vertical keystone correction and vertical height distortion correction when the video is projected by a projector at a non-zero tilt angle. The multi-purpose scaler is also arranged to provide interlacing and de-interlacing of the video frames as necessary.

According to the document, keystone distortion correction is provided together with resampling. However, this particular architecture of a scaler works line-wise and separately for horizontal and vertical direction and hence appears to be suitable only for simple trapezoidal distortions. The aspect-ratio preservation throughout whole image is not guaranteed. Also, the document does not relate to multi-projectors systems.

Document US 2009/0278999 discloses a video projector including a display device which receives an image signal and generates image light projected on a projection surface. A scaling processor scales the input image signal. An OSD processor generates and corrects an adjustment pattern image in accordance with a correction instruction on the projection surface. An image signal synthesizer combines the image signal processed by the scaling processor with an OSD image signal generated and corrected by the OSD processor to generate a combined image signal. A trapezoidal distortion corrector performs trapezoidal distortion correction on the combined image signal from the image signal synthesizer based on the correction of the adjustment pattern image on the projection surface. The adjustment pattern image generated by the OSD processor includes a reference quadrangle pattern and downsized quadrangle patterns, which are reduced in size from the reference quadrangle pattern.

Keystone distortion correction is provided together with rescaling. However, the document does not disclose multi-projection.

Thus, there is a need for enhancing geometric distortion correction techniques, in particular in the context of multi-projector systems. According to a first aspect of the invention there is provided a method of processing an original image for projection on a projection screen by a projector, comprising performing pixel interpolation between pixels of a first image associated with the original image and pixels of a second image associated with a pixel grid of the projector, wherein at least one of the first image and the second image has a pixel resolution greater than the resolution of, respectively, the original image and the pixel grid.

The pixel grid of the projector corresponds to its matrix of pixels. In order to display an image, each pixel of the grid (or matrix) is set, for example, to a colour and a luminosity. The grid has a fixed number of pixels and a fixed shape (most commonly rectangular). However, according to the invention, the grid may not be used as such for the interpolation from which the definition (or setting) of the pixels is determined. An original version may be used, i.e. the grid as such (same number of pixels and same shape). An upscaled version may be used, i.e. a grid with the same shape and a higher number of pixels. Other versions may be used. Interpolation may be performed between the original version of the image data and an upsampled version of the pixel grid, between an upsampled version of the image data and an original version of the pixel grid or between two upscaled versions of the image data and the pixel grid.

The present invention makes it possible to display high-definition (HD) videos with flexibility and low complexity.

Interpolation is carried out at a higher spatial resolution than given by the original image or the pixel grid. Consequently, pixelization artifacts may be reduced.

For example, the original image is upscaled for obtaining the first image, thereby leading to a pixel resolution of the first image greater than the pixel resolution of the original image.

Since upscaling is performed before interpolation, the upscale factor may be selected and modified with high flexibility.

The original image may be upscaled according to an upscale factor determined in order to reduce a difference between a first pixel density of the obtained first image and a second pixel density of the second image.

Thus, interpolation techniques, in particular nearest-neighbour interpolation, may give better results.

The original image may be upscaled to said second pixel density.

The second pixel density of the second image may be chosen to be substantially equal to said first pixel density.

For example, the original image is upscaled according to an upscale factor determined according to a zoom command.

Performing upscaling before interpolation enables to provide an easily implementable flexible digital zooming function. Indeed, the upscale factor may be modified according to the digital zoom resolution commanded.

For example, a zoom-in command is received and a current upscale factor used for the upscaling is increased.

Inversely, a zoom-out command is received and a current upscale factor used for the upscaling is decreased.

The second image may have a pixel resolution greater than the resolution of the pixel grid and the method may further comprise downscaling the second image after performing pixel interpolation between the first image and the second image to the resolution of the pixel grid. Downscaling, after interpolation may further reduce residual artifacts persisting after interpolation.

At least one of the upscaling and the downscaling may be performed in a frequency domain.

Thus, the block size (hence the scale factor) may be easily adapted.

For example, upsampling and/or downsampling use Discrete Cosine Transforms (DCT).

Thus, DCT and inverse DCT (IDCT) of an n*n pixel block have O(n²*log n) time complexity and process n² pixels at once.

For example, the pixel interpolation is a nearest-neighbour interpolation.

Thus, implementation is less complex than other interpolation techniques.

However, other techniques may be used such as bi-linear or bi-cubic interpolation.

The second image may be downscaled according to a downscale factor determined according to a zoom command.

Thus, the digital zoom functionality is performed using the downscale factor.

For example, a zoom-in command is received and a current downscale factor used for downscaling the second image obtained after performing the pixel interpolation is decreased.

Inversely, a zoom out command is received and, a current downscale factor used for downscaling the second image obtained after performing the pixel interpolation is increased.

According to a second aspect of the invention there is provided a method of processing an original image for projection on a projection screen by a plurality of projectors, comprising the following steps:
dividing said original image into image portions, each image portion being intended to be projected on the projection screen by a respective projector, and
processing each image portion according to the first aspect.

Thus, the method is adapted to multi-projector systems.

The method may further comprise upscaling the image portions for obtaining the respective first images, thereby leading to a pixel resolution of the first images greater than the pixel resolution of the respective image portions, and a step of blending the image data portions after upscaling.

Thus, transition between image portions may be smoother.

According to a third aspect of the invention there is provided an image processing device for processing an original image for projection on a projection screen by a projector, comprising a control unit configured to perform pixel interpolation between pixels of a first image associated with the original image and pixels of a second image associated with a pixel grid of the projector, wherein at least one of the first image and the second image has a pixel resolution greater than the resolution of, respectively, the original image and the pixel grid.

The control unit may be further configured to upscale the original image for obtaining the first image, thereby leading to a pixel resolution of the first image greater than the pixel resolution of the original image.

The original image may be upscaled according to an upscale factor determined in order to reduce a difference between a first pixel density of the obtained first image and a second pixel density of the second image.

The original image may be upscaled to said second pixel density.

The second pixel density of the second image may be chosen to be substantially equal to said first pixel density.

The original image may be upscaled according to an upscale factor determined according to a zoom command.

The control unit may be further configured to increase a current upscale factor used for the upscaling, when receiving a zoom in command.

The control unit may be further configured to decrease a current upscale factor used for the upscaling when receiving a zoom out command.

The second image may have a pixel resolution greater than the resolution of the pixel grid and the control unit may further be configured to downscale the second image after performing pixel interpolation between the first image and the second image to the resolution of the pixel grid.

At least one of the upscaling and the downscaling may be performed in a frequency domain.

The pixel interpolation may be a nearest-neighbour interpolation, a bi-cubic interpolation, or a bi-linear interpolation.

The second image may be downscaled according to a downscale factor determined according to a zoom command.

When receiving a zoom in command, a current downscale factor used for downscaling the image data obtained by performing the pixel interpolation may be decreased.

When receiving a zoom out command, a current downscale factor used for downscaling the image data obtained by performing the pixel interpolation may be increased.

According to a fourth aspect of the invention there is provided an image processing device for processing an original image for projection on a projection screen by a plurality of projectors, according to the third aspect, wherein the control unit is further configured to divide said original image into image portions, each image portion being intended to be projected on the projection screen by a respective projector, and for at least one image portion, to perform pixel interpolation between pixels of a first image associated with the image portion and a second image associated with a pixel grid of the respective projector, wherein at least one of the first image and the second image has a pixel resolution greater than the resolution of, respectively, the image portion and the pixel grid.

The control unit may be further configured to perform blending on the at least one image data portion after upscaling.

According to a fifth aspect of the invention there is provided a video projection system comprising:
at least one device according to the third or the fourth aspect, and
at least one projector for projecting images processed by the device on a projection screen.

The at least one projector may embed the control unit of the device. Thus, image processing maybe distributed in the system.

According to a sixth aspect of the invention there are provided computer programs and computer program products comprising instructions for implementing methods according to the first, and/or second aspect(s) of the invention, when loaded and executed on computer means of a programmable apparatus such as an image processing device.

According to an embodiment, information storage means readable by a computer or a microprocessor store instructions of a computer program, that it makes it possible to implement a method according the first and/or the second aspect of the invention.

The objects according to the second, third, fourth, fifth, and sixth aspects of the invention provide at least the same advantages as those provided by the method according the first aspect of the invention.

The following description is also directed to aspects relating to execution of commands in a multi-projection system.

Other features and advantages of the invention will become apparent from the following description of non-limiting exemplary embodiments, with reference to the appended drawings, in which:

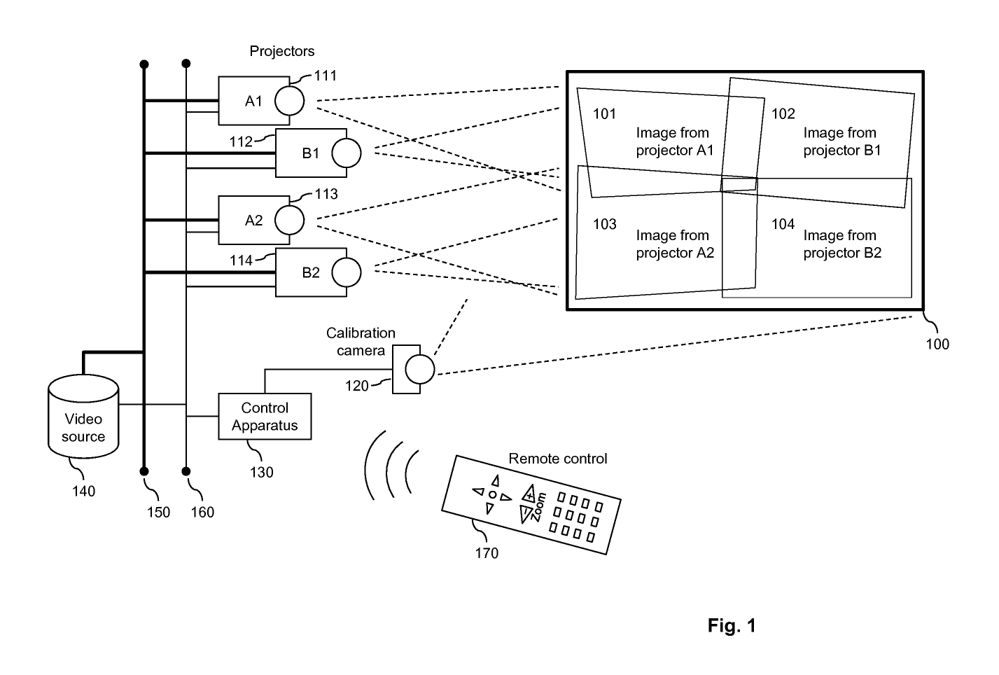

FIG. 1 illustrates a multi-projector system;

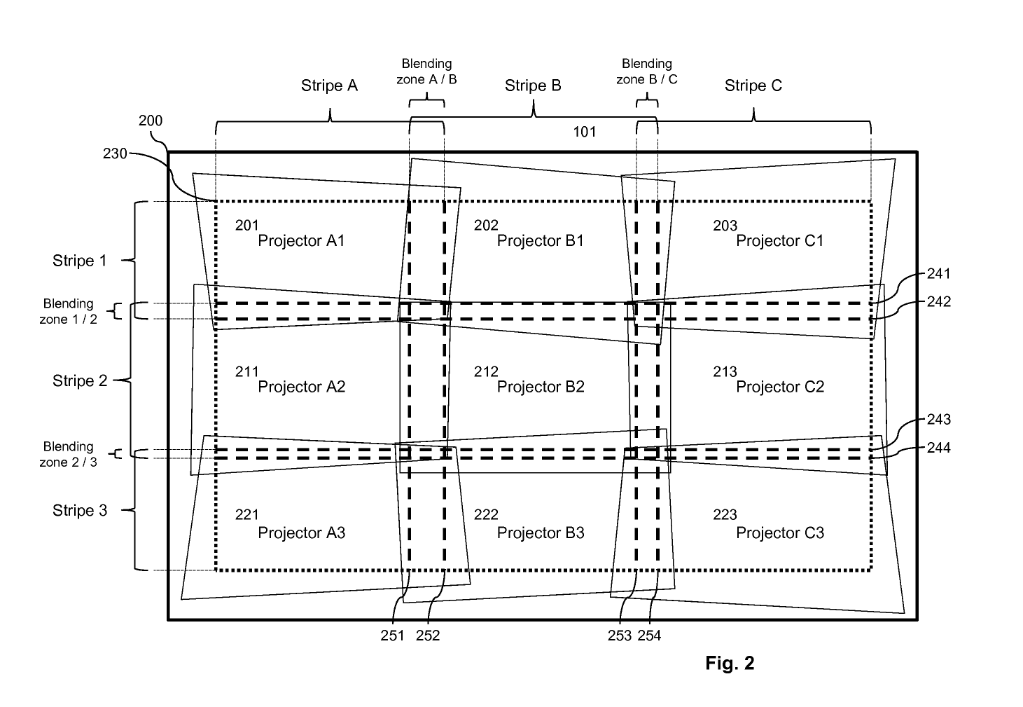

FIG. 2 illustrates projection of image portions by projectors and blending of the image portions projected;

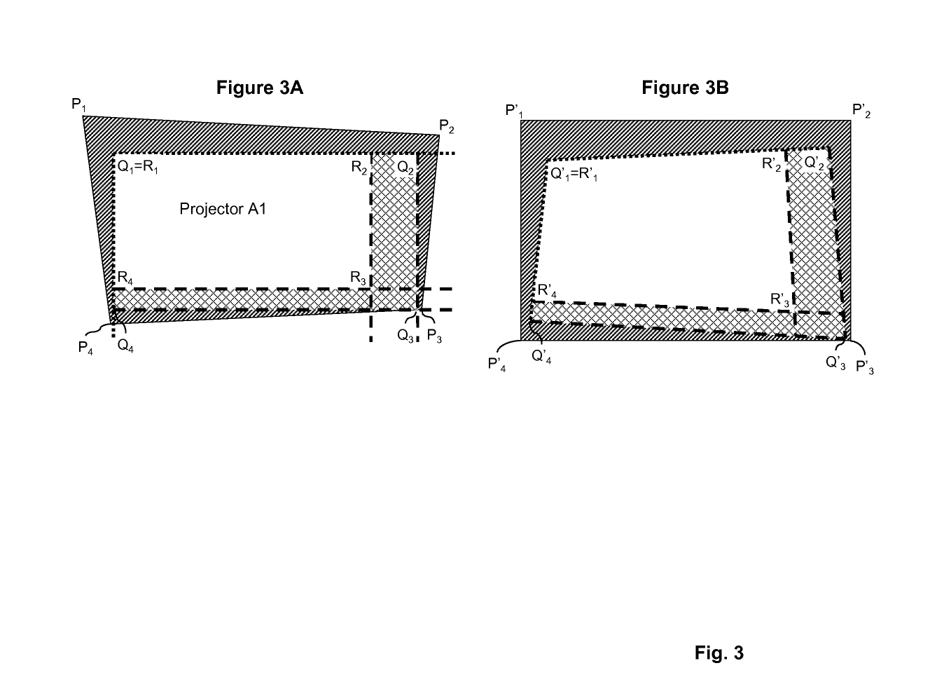

FIGS. 3A and 3B illustrate distortion correction for one of the projectors of FIG. 2;

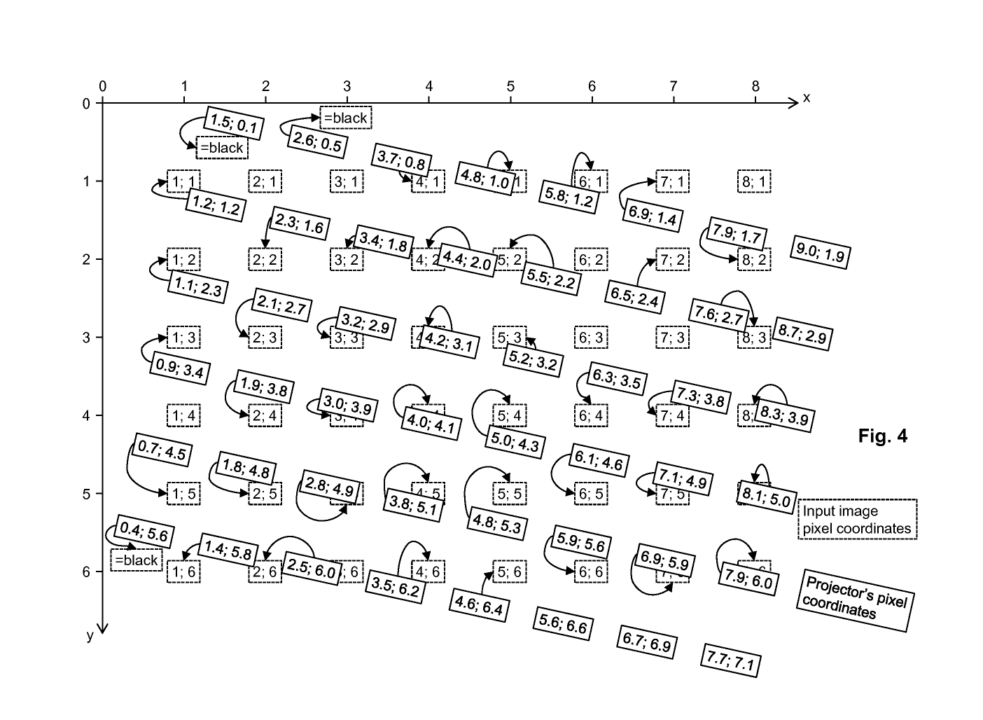

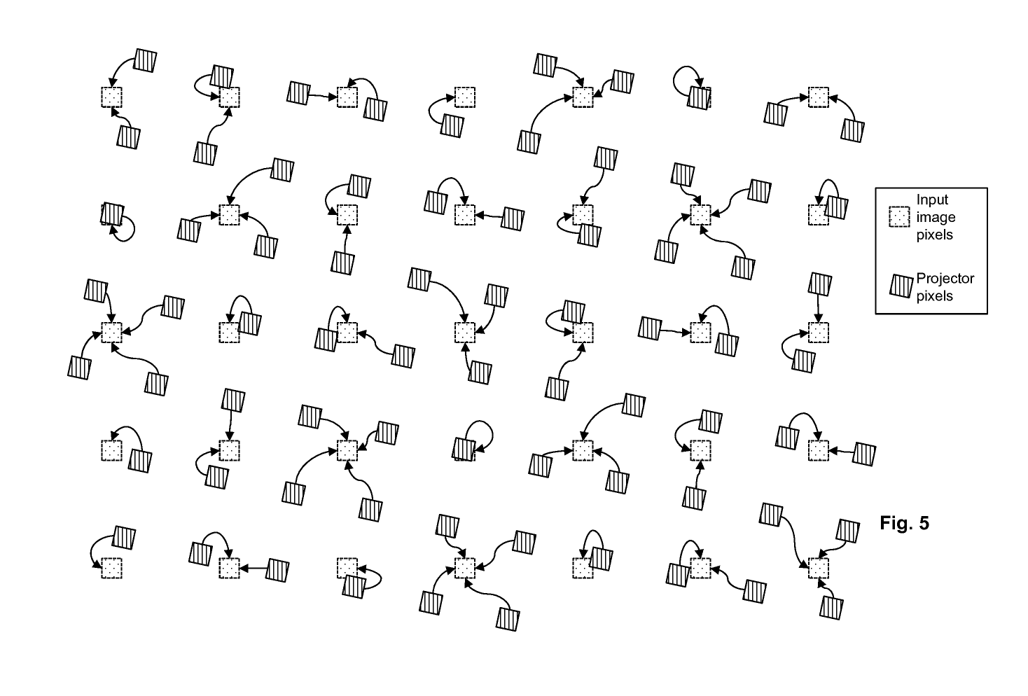

FIG. 4 illustrates nearest-neighbour interpolation;

FIG. 5 illustrates the artifact generation problem due to a pixel distribution denser at the projector than in the input image;

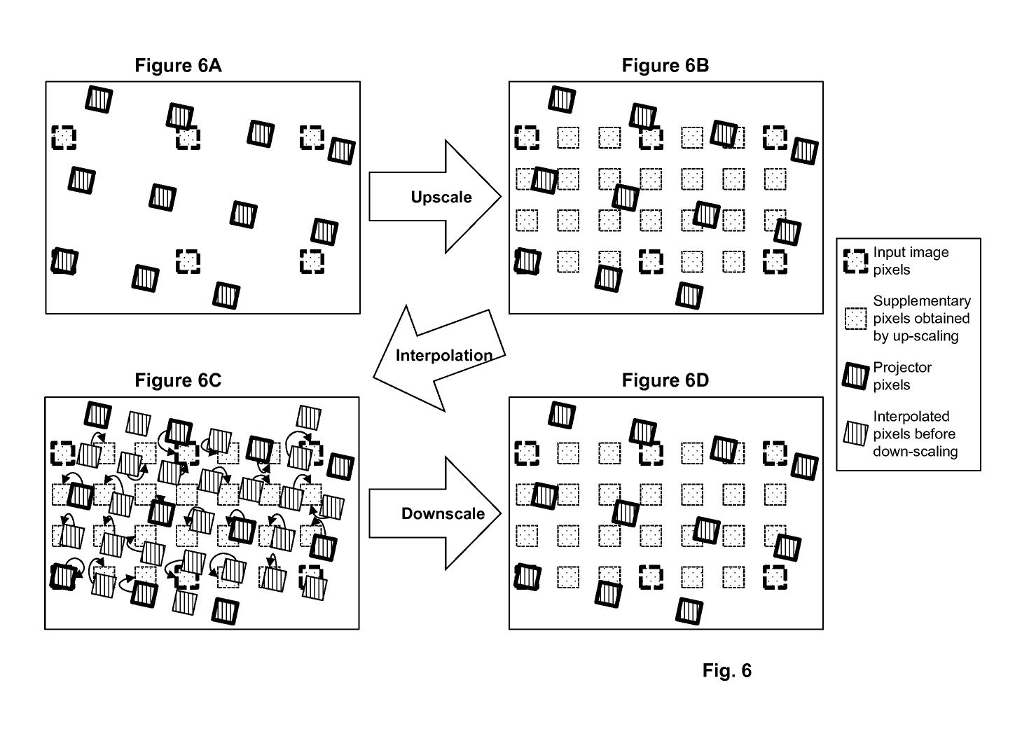

FIGS. 6A, 6B, 6C and 6D illustrate a solution to the artifact generation problem according to embodiments of the invention;

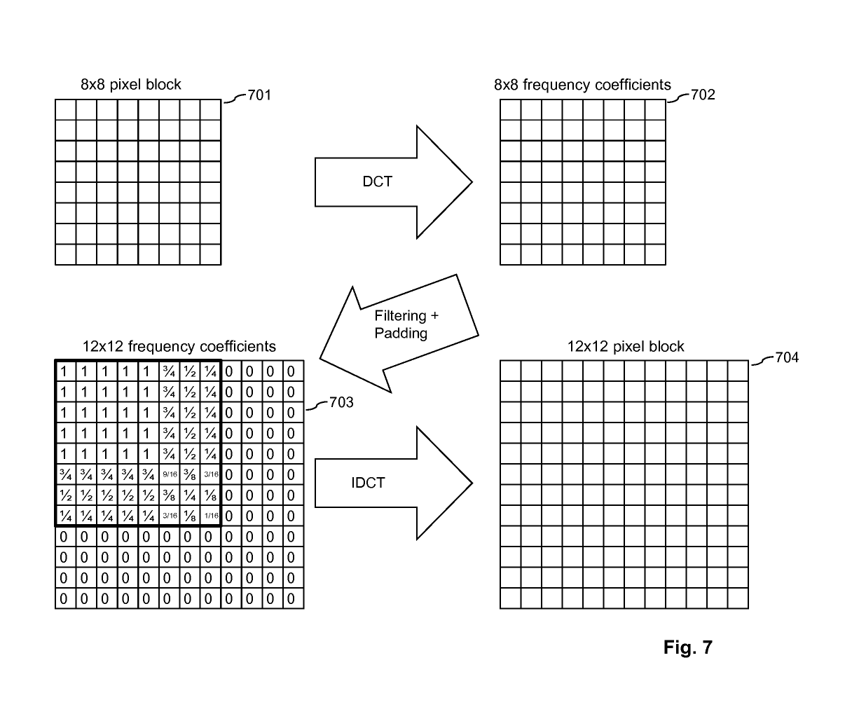

FIG. 7 illustrate up-scaling in the frequency domain;

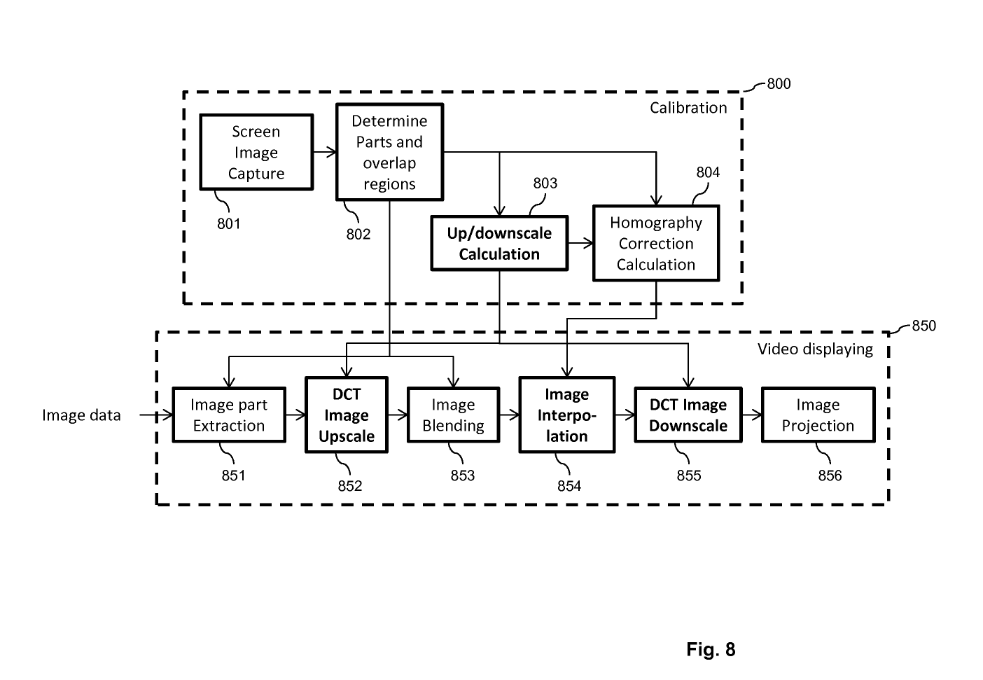

FIG. 8 is schematic illustration of a video-projector according to embodiments of the invention;

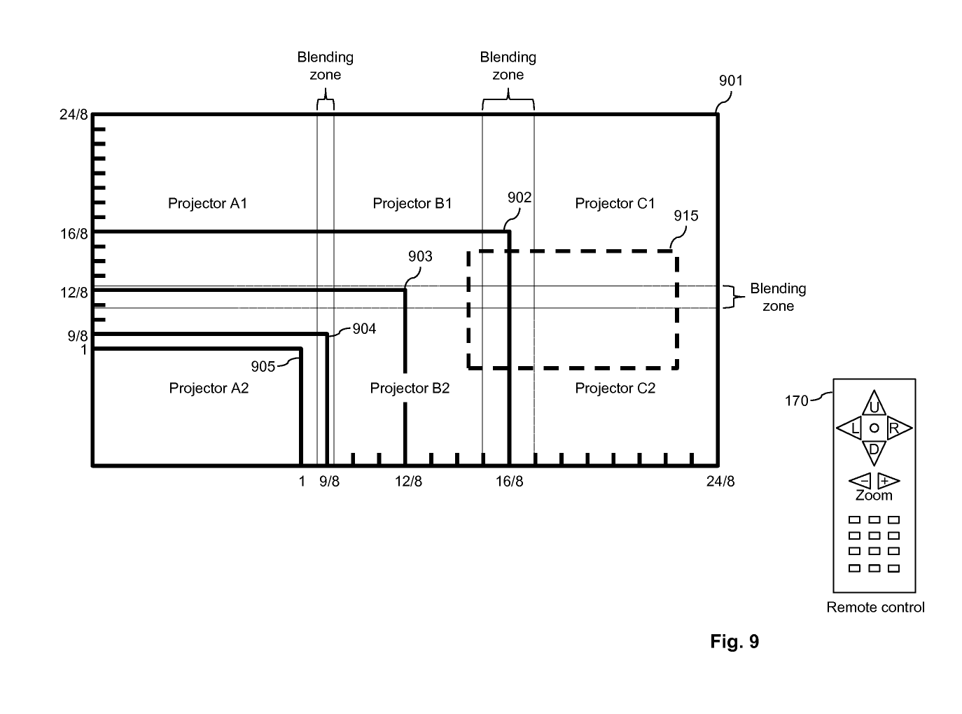

FIG. 9 illustrates digital zooming according to embodiments of the invention;

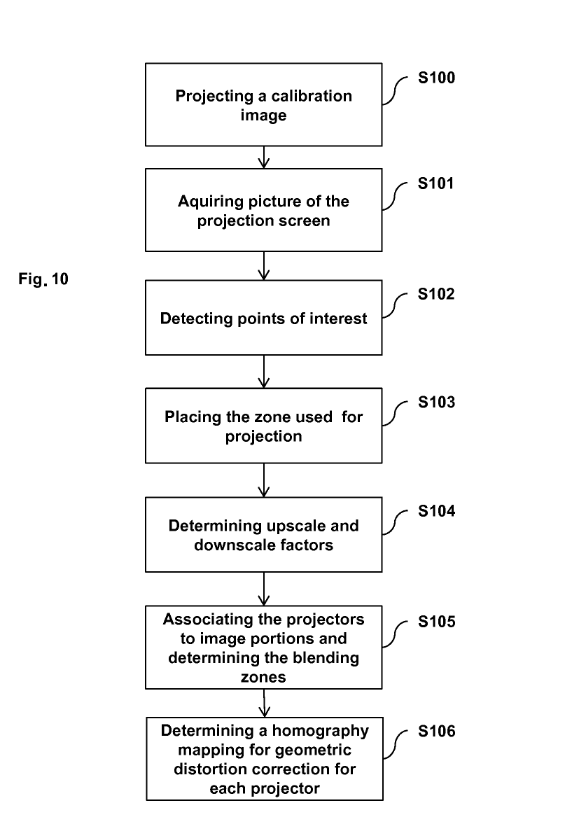

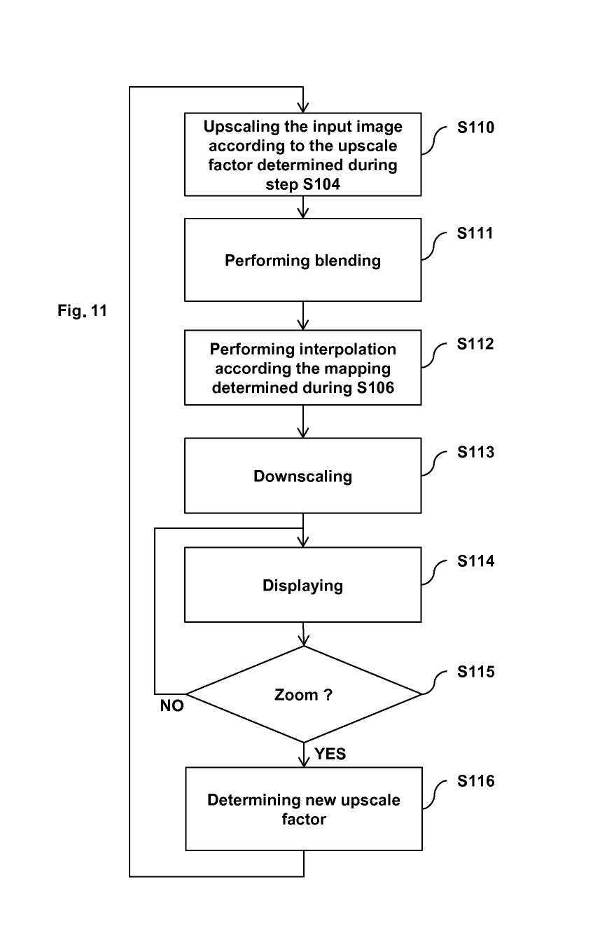

FIGS. 10 and 11 are flowcharts of steps of methods according to embodiments of the invention;

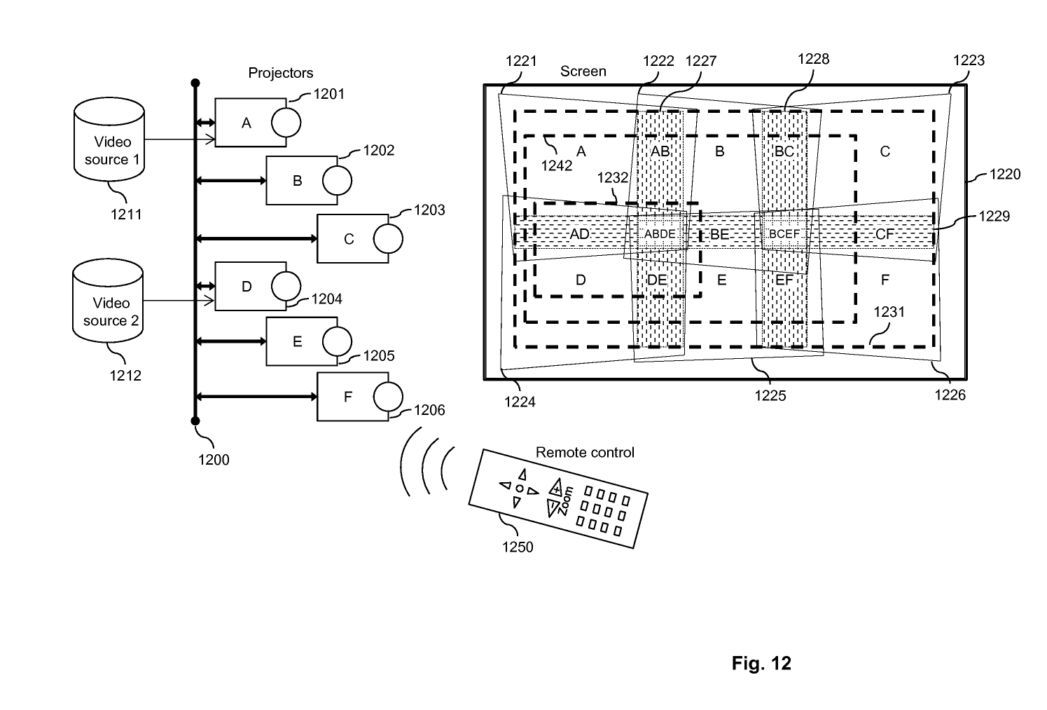

FIG. 12 is an overview of a multi-projection system for displaying videos or still pictures, together with the resulting projection screen layout;

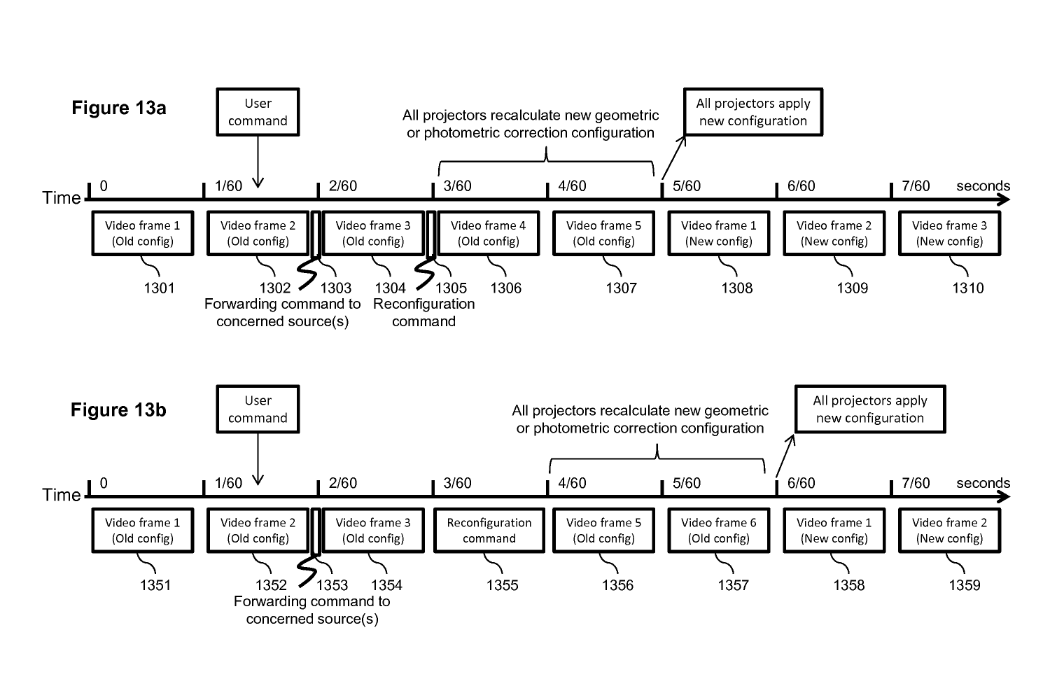

FIGS. 13a and 13b show examples of timelines for video frame transmission and reconfiguration command transmission on the inter-projector network;

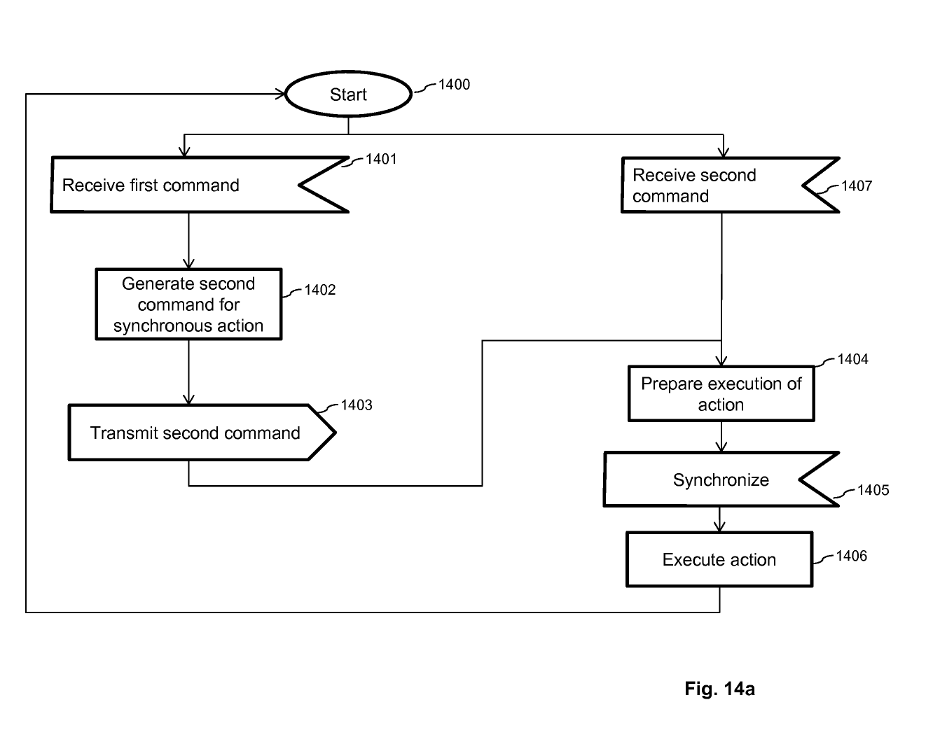

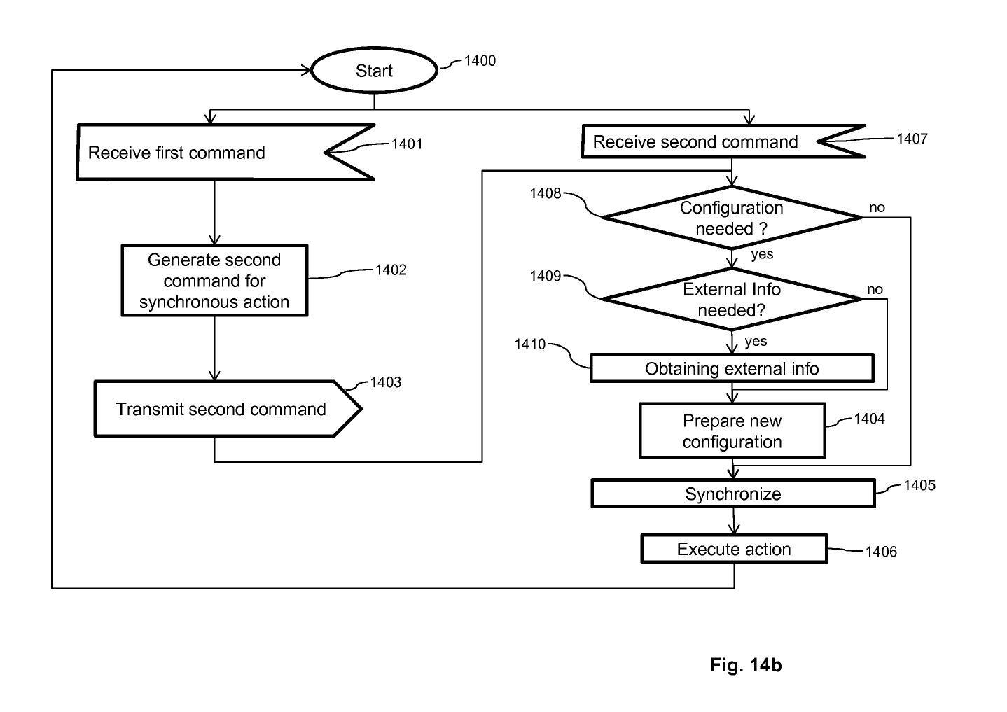

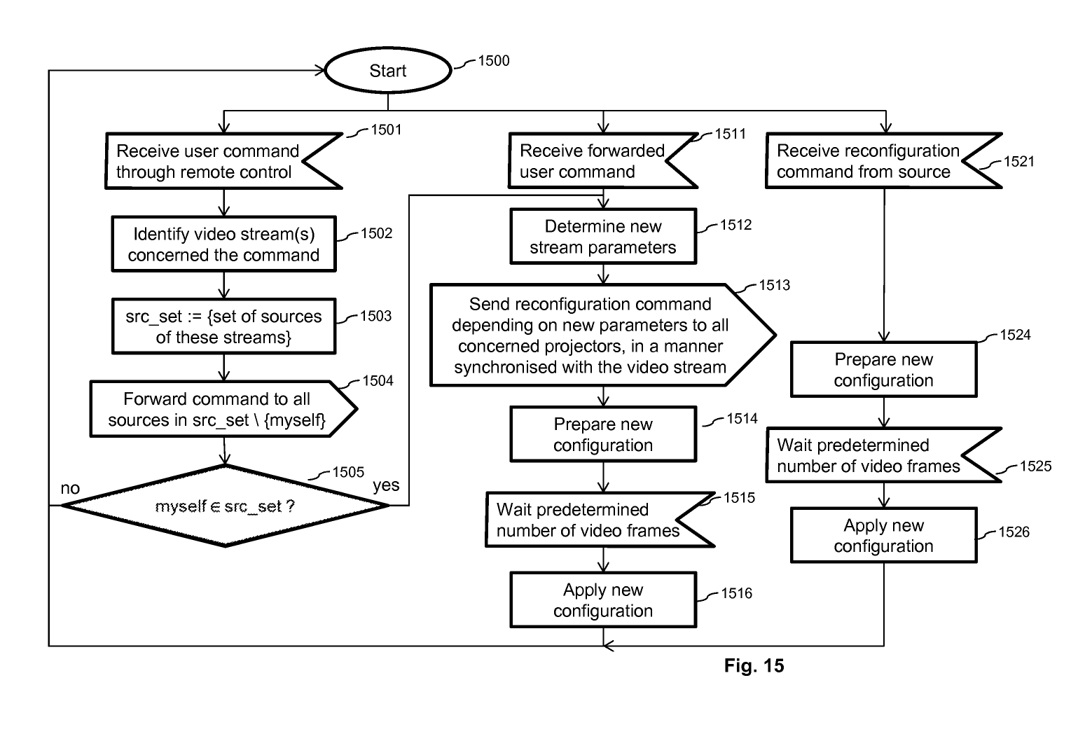

FIGS. 14a, 14b and 15 are flowcharts of steps for processing a command;

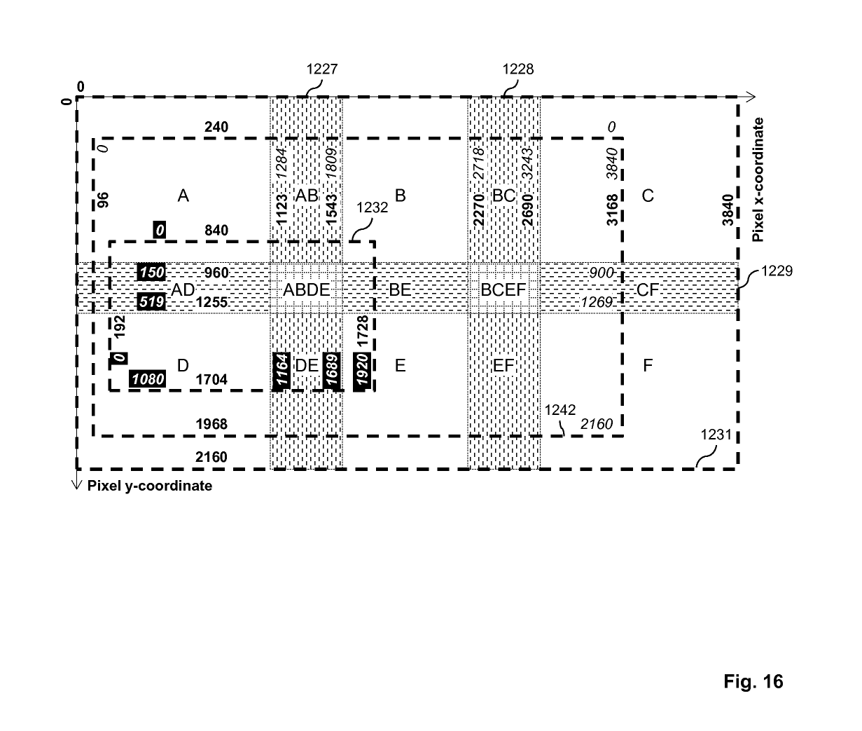

FIG. 16 is an exemplary picture-in-picture display with video cut parameters that change in response to a display window zoom command;

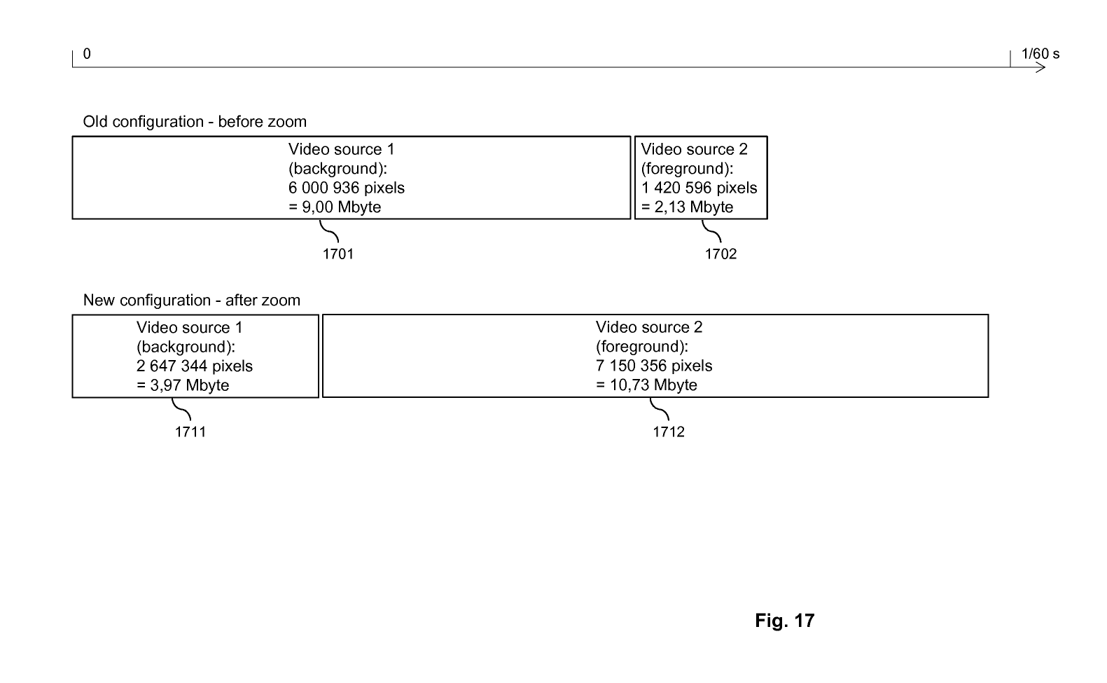

FIG. 17 is an exemplary video data frame layout;

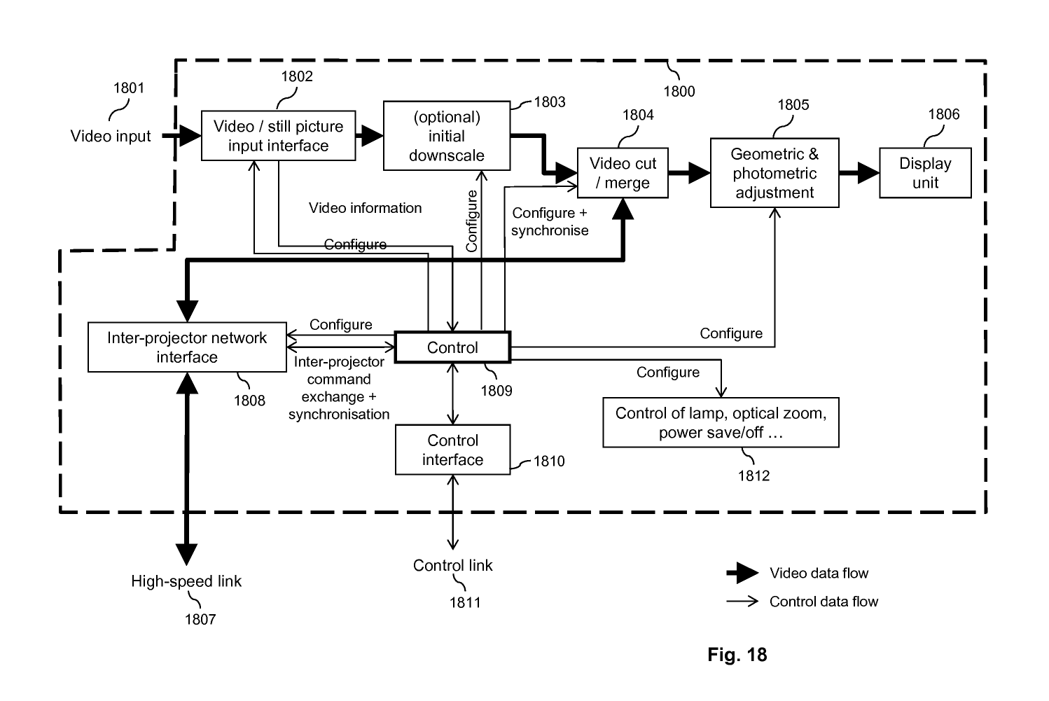

FIG. 18 is a functional diagram of a video projector device.

In what follows, there is described a method of predistorting an original image, thereby obtaining a predistorted image in which, when projected on a projection surface (or “screen” in what follows), keystone distortion is suppressed or at least reduced. The method comprises performing an interpolation between a first image associated with the original image to be displayed and a second image associated with the predistorted image displayed (or the pixel grid of the projector used for displaying the image). At least one of the first and the second images is a respective oversampled version of the original and the predistorted image.

FIG. 1 illustrates an exemplary multi-projector system having four video projectors 111 (A1), 112 (B1), 113 (A2) and 114 (B2). The system may have any other number of projectors. The projectors may be assembled according to several configurations. In the context of the system in FIG. 1, the projectors have a “rectangular” configuration, i.e., the projectors are disposed at the corners of a virtual rectangle.

Each projector projects light on respective convex quadrilateral projection areas 101, 102, 103 and 104 of a projection screen 100, thereby displaying respective images (or portions of image). Given the “rectangular” configuration of the projectors, the four areas are arranged in two horizontal rows and two vertical columns. The projection areas may overlap.

The projectors' optical axes may not be perfectly orthogonal to the plane of the projection screen 100. Also, the mounting of the projectors may have mechanical tolerances. Hence, the projection areas 101, 102, 103 and 104 may be geometrically distorted. For example, the quadrilaterals projected by the projectors are not perfect rectangles and the borders of the projected quadrilaterals are not perfectly parallel to the borders of the screen 100 whereas the projectors project rectangular input (portions of) images.

During system installation or power-up, a calibration process may be needed in order to gather the required data for properly dividing the images to be projected into several portions to be respectively displayed by the projectors and for taking into account the overlapping of the projection areas of the projectors and the geometric distortion.

A digital calibration camera 120 may therefore be provided for acquiring one or several photos of the entire surface of screen 100 with the four images from the projectors displayed on the projection areas 101, 102, 103 and 104.

In case screen 100 is flat, one single photo of the screen while all projectors 111, 112, 113 and 114 simultaneously project a uniformly white or grey image may be sufficient. In case screen 100 has a curved surface (for example cylindrical, spherical or a dome), it may be preferable to acquire several photos respectively corresponding to the projectors. Each photo is acquired while a single projector projects a predetermined calibration pattern. For example, the pattern comprises a regular, triangular, or a square tiling (checker board), so that the geometric distortion introduced by the non-planarity of screen 100 can be mathematically evaluated and compensated for.

In FIG. 1, a single calibration camera has been represented. However, several cameras may be provided. For example, each one of the projectors 111, 112, 113 and 114 may be associated with a respective calibration camera, covering the projection area corresponding to the projector.

In case a single camera cannot acquire a picture of the entire projection screen, it may be used for acquiring several images at several positions for reconstituting the entire projection screen.

For the sake of conciseness, while the present invention may apply to flat or curved screens, in the following description, it is assumed that the screen is flat (unless otherwise stated).

The projectors 111, 112, 113 and 114 of the system are connected to a control network 160. The projectors are controlled by a control apparatus 130, also connected to the control network, that it is configured to communicate to the projectors parameters for geometric distortion correction and coordinates defining the portion of the video image that each projector has to project, including the blending (overlapping) zones. The parameters and coordinates are further described in what follows, with reference to FIG. 3.

The control apparatus may be comprised in one of the projectors of the system. The projector embedding the control apparatus thus acts as a master device in the control network and other projectors act as slave devices.

Alternatively, the control apparatus may have one or several functional modules distributed in the control network. For example, several projectors may embed one or several functional modules. In particular, the master projector may embed the modules performing the processing that needs to be centralized and slave projectors embed modules performing the remaining processing. The so distributed modules may communicate and exchange information through the control network 160.

The system illustrated in FIG. 1 further comprises an HD video source 140 such as a digital video camera, a hard-disk or solid-state drive, a digital video recorder, a personal computer, a set-top box, a video game console or similar.

The HD video source is connected to the projectors through a high-speed, low latency video network 150 (wired or wireless LAN) offering a data rate sufficient for transporting HD video, for example IEEE 802.11, IEEE 802.3 or device connecting type technologies such as W-HDMI, IEEE 1394 or USB.

The format of the data output by the video source may be compressed (MPEG, H.264 or similar) or not compressed (RGB, YCbCr with or without chroma subsampling, or similar). The resolution of the video data may be 1080p (1920×1080) or higher. The colour depth may be 24 or 36 bits/pixel. The frame rate may be 30 or 60 frames/second.

The video transmission on network 150 may be point-to-multipoint (i.e. each projector receives the whole video stream) or point-to-point (i.e. each projector receives only a part of the video stream, representing the portion of the image said projector is in charge of projecting).

While video network 150 and control network 160 have been presented separately, it is possible to have a single network acting as both video and control networks.

Control apparatus 130 may also be configured to receive commands from a remote control 170 (e.g. through an infrared link), in particular commands for zooming and shifting the image displayed on the projection screen (zooming and shifting are further detailed with reference to FIG. 9). The control apparatus may be further configured to receive commands directed to the video source (play, start, stop, program select etc.). The control apparatus is thus configured to forward the commands to the video source 140 through the control network 160.

Furthermore, the video source 140 communicates the video resolution to the control apparatus 130 through the control network 160.

FIG. 2 illustrates a flat projection screen 200 on which nine image portions are projected by projectors (not represented) arranged in three horizontal rows and three vertical columns. The projectors may be part of a system as described with reference to FIG. 1. In FIG. 1, the system has four projectors while in the context of FIG. 2 it has nine projectors.

Each projector A1, B1, C1, A2, B2, B3, C1, C2, C3 covers a respective quadrilateral area on the screen 201, 211, 221, 202, 212, 222, 203, 213, 223. In FIG. 2, the quadrilateral areas are delimited by thin solid lines.

The set of projected image portions represents the image acquired by a control apparatus (such as control apparatus 130 in FIG. 1) through one or several calibration cameras (such as calibration camera 120 in FIG. 1). The control apparatus may compensate for the perspective distortion introduced by the one or several calibration cameras whose optical axis may not be perfectly orthogonal to the plane of the projection screen when acquiring the image. The control apparatus may also compensate for the orientation of the one or several calibration cameras which may not be perfectly horizontal.

The compensation may be performed using the borders of the screen 200 which appear in the image and that may be used as orientation marks. In FIG. 2, the borders of the screen are delimited by bold solid lines.

Once the image (formed by the projected image portions) is acquired, a rectangular projection area 230 (delimited in FIG. 2 by thick dotted lines) is placed by the control apparatus on the screen. The borders of rectangular portion area 230 are parallel to the borders of the screen area 200 and the rectangular portion area has an aspect ratio (between width and height) corresponding to the aspect ratio of the input video from the video source of the system (e.g. 1920:1080=16:9). Also, the rectangular portion area is comprised within the screen zone illuminated by the projectors (namely the union of areas 201, 202, 203, 211, 212, 213, 221, 222 and 223).

Within the rectangular projection area 230, horizontal delimiting lines 241, 242, 243, 244 and vertical delimiting lines 251, 252, 253, 254 (represented in FIG. 2 by bold dashed lines) are defined by the control apparatus defined as follows:
Line 241 is the upmost horizontal line contained within the zone covered by areas 211, 212 and 213;
Line 242 is the lowest horizontal line contained within the zone covered by areas 201, 202 and 203;
Line 243 is the upmost horizontal line contained within the zone covered by areas 221, 222 and 223;
Line 244 is the lowest horizontal line entirely contained within the zone covered by areas 211, 212 and 213;
Line 251 is the leftmost vertical line entirely contained within the zone covered by areas 202, 212 and 222;
Line 252 is the rightmost vertical line entirely contained within the zone covered by areas 201, 211 and 221;
Line 253 is the leftmost vertical line entirely contained within the zone covered by areas 203, 213 and 223;
Line 254 is the rightmost vertical limit entirely contained within the zone covered by areas 202, 212 and 222.

The vertical delimiting lines divide the rectangular portion area into three vertical overlapping stripes A, B and C. Stripe A is the vertical stripe from the left border of area 230 to line 252, stripe B s the vertical stripe from line 251 to line 254 and stripe C is the vertical stripe from line 253 to the right border of area 230.

Furthermore, the horizontal delimiting lines divide the rectangular portion area into three horizontal overlapping stripes 1, 2 and 3. Stripe 1 is the horizontal stripe from the upper border of area 230 to line 242, stripe 2 the horizontal stripe from line 241 to line 244 and stripe 3 the horizontal stripe from line 243 to the lower border of area 230.

The overlapping zone between stripes A and B is delimited by lines 251 and 252 and the overlapping zone between stripes B and C is delimited by lines 253 and 254.

The overlapping zone between stripes 1 and 2 is delimited by lines 241 and 242 and the overlapping zone between stripes 2 and 3 is delimited by lines 243 and 244.

The overlapping zones are used for performing blending between image portions projected on these zones.

Each intersection of a horizontal stripe and a vertical stripe corresponds to a rectangular part of the input video to be projected by one single projector. For example, the intersection of stripe A and stripe 1 is situated entirely within the area 201 illuminated by projector A1. Therefore, this zone will be illuminated by projector A1 only. However, in the overlapping zones, projector A1 illuminates in coordination (blending) with its neighbouring projectors (B1, A2 and B2).

The coordinates are then respectively distributed by the control apparatus to each of the respective projectors A1, B1, C1, A2, B2, C2, A3, B3 and C3. Thus, for example, projector A1 is in charge of projecting the rectangular video chunk from pixel (1, 1) to pixel (671, 345). Also, projector A1 has to perform horizontal blending with decreasing brightness from pixel column 568 to 671 and vertical blending with decreasing brightness from pixel row 299 to 345.

Additionally, the control apparatus determines and distributes a common upscale factor and a common downscale factor to be applied by all projectors before and respectively after an interpolation step described hereinafter. These factors are determined so that the ratio of the number of pixels in the upscaled chunk per projector of input image by the number of pixels in the keystone-corrected image prior to down-scaling is close to 1:1 for all projectors.

Furthermore, implementation constraints of the upscaling and downscaling algorithms may be taken into account. For instance, if rescaling in the frequency domain is used (as described with reference to FIG. 7), the granularity of available scale factors may be determined with the input block size, e.g. with input block sizes of 8×8, the scale factor (upscale or downscale) may vary in steps of ⅛. Considering video projectors with a resolution of, for example, 1400×1050, the upscale factor may be chosen equal to 3.0 and the downscale factor equal to 2.0.

FIG. 3A is a detailed illustration of the area 201 of FIG. 2. This area of the projection screen 200 corresponds to the quadrilateral projection area of projector A1. The corners of the quadrilateral area are marked P1, P2, P3 and P4 in FIG. 3A. The corners of the zone delimited by the rectangular projection area 230 of FIG. 2 and lines 242 and 252 are marked Q1, Q2, Q3 and Q4. The corners of the zone delimited by the rectangular projection area and lines 241 and 251 are marked R1, R2, R3 and R4.

Since projector A1 is in charge of projecting the top-left corner of the input image, points Q1 and R1 coincide, point R2 is situated on the line Q1-Q2 and point R4 is situated on the line Q1-Q4. For the other projectors, depending on their position, other similar coincidences or none at all may exist.

In the white zone in the quadrilateral R1-R2-R3-R4, projector A1 projects with full brightness (i.e. projector A1 is the only one in charge of projecting) while in the x-hatched zone rest of the image area, blending with neighbouring projectors needs to be applied. The dark diagonally-hatched area outside the image rectangle R1-Q2-Q3-Q4 remains black (projector A1 does not project light on it).

FIG. 3B illustrates the “inverse” distortion performed by the control apparatus for cancelling the effect of the “physical” geometric distortion induced by projector A1. In other words, FIG. 3B shows the same areas and zones as FIG. 3A, but as defined in the pixel grid of projector A1. In other words, FIG. 3B may be seen as an illustration of the pixel grid of projector A1 with the pixels set so as to project distortion corrected images on the projection screen. The points in FIG. 3B corresponding to points in FIG. 3A have the same name with primes (′) added in the name. For example, points P′1, P′2, P′3 and P′4 respectively correspond to points P1, P2, P3 and P4.

When the image portion illustrated in FIG. 3B is projected on the projection screen, it is distorted as illustrated in FIG. 3A, but since it has been “inversely” distorted before projection, the final result is a proper image without distortion. The viewer can thus see the original image (at the video source) properly projected on the screen. In FIG. 3B, the quadrilateral areas delimited by corners Q′1, Q′2, Q′3 and Q′4 and by corners R′1, R′2, R′3 and R′3 thus respectively correspond to the quadrilateral areas Q1, Q2, Q3 and Q4 and by corners R1, R2, R3 and R3 in FIG. 3A.

The “inverse” distortion may be performed by using homography, in particular for flat screens. Such technique may be implemented using a three by three (3×3) matrix with real coefficients and which can be determined from four points from the original image and the four corresponding points in the image projected during calibration. For example points P1, P2, P3 and P4 in FIG. 3A and the corresponding points P′1, P′2, P′3 and P′4 may be used.

Interpolation tables may also be used, in particular for curved screens. Corresponding algorithms of the known art may be used.

Geometric distortion correction (comprising the calibration and the “inverse” distortion) may be performed by each projector separately. Thus, image processing may be distributed within the multi-projector system.

During the geometric distortion correction, interpolation may be used. In particular, nearest-neighbour interpolation may be used. Implementation of such interpolation is simple and has low processing cost.

Nearest-neighbour interpolation is presented with reference to FIG. 4.

The coordinates of each projector pixel is expressed in the coordinates system of the original image to be projected. In FIG. 4, the x axis and the y axis belong to the coordinates system of the original image (or input image). The pixels of the original image are represented in dashed rectangles. The projector's pixels, expressed in the coordinates system are represented in the non-dashed rectangles.

It is assumed that the area of the image portion to be projected is defined by the rectangle formed by the points having the following coordinates in the original image's coordinates system: (1, 1), (8, 1), (8, 6) and (1, 6).

The projector's pixels falling outside the rectangle are set to black. The projector's pixel falling into the blending zone(s) (not represented) are set to colours attenuated according to a blending coefficient (between 0 and 1) determined as a function of the distance to between the pixels and the borders of blending zone(s).

The other pixels (falling inside the rectangle and outside the blending zones), are set to the colour of their respective nearest original image neighbour pixel. If the original image pixels are situated on a regular rectangular grid with consecutive integer coordinates, the nearest-neighbour pixels may be obtained by rounding the projector pixel's coordinates to nearest integers.

For example, in FIG. 4, projector pixels (1.5, 0.1), (2.6, 0.5) and (0.4, 5.6) fall outside the input image area and are set to black. For the other projector pixels, an arrow points to the nearest-neighbour input image pixel (the projector pixel (1.2, 1.2) is set to the same colour as the input image pixel (1, 1), etc.). The correspondence between the pixels in the input image and the projector's pixels constitutes a mapping.

We see that in the illustrated case, the colour of some original image pixels is not taken into account because no projector pixel has them as nearest neighbours (this is the case for pixels (2, 1), (3, 1), (6, 2), (6, 3), (7, 3), (1, 4) and (3, 6). This may cause loss of image quality because fine image features could disappear.

When the repartition of the projector pixels is more dense than the repartition of the pixels of the original image (or input image), a problem, illustrated in FIG. 5 may rise. In a multi-projector system, it is likely that the resolution of the aggregated projectors is higher than the original (input) image resolution. For a given input image pixel there exist several adjacent projector pixels having said input image pixel as nearest neighbour. Consequently, the several adjacent pixels are set to the same colour. For example, in FIG. 5, input image pixels may have up to four projector pixels pointing to them as nearest neighbours.

As a result, unequal distribution of input colours and visually annoying blocking artifacts may occur.

FIG. 5 illustrates the case wherein the repartition of the pixels of the input image is more dense than the repartition of the pixels of the projector's pixel grid. However, the problem evocated hereinabove also rises when the pixel repartition density higher in the input image than in the projector's pixel grid.

When pixel repartition is more dense in the projector's grid, upscaling is to be performed on the input image. When pixel repartition is more dense in the input image, upscaling is performed on the projector's grid. Upscaling may also be performed on both the input image and the projector's pixel grid.

Attention is paid to the fact that, the version of the input image and the version of the projector's pixel grid used enable a proper interpolation. For example, when using nearest-neighbour interpolation, the versions determined make it possible for each pixel of the input image or the pixel grid to have a unique nearest neighbour.

When the input image (respectively, the projector's pixel grid) is not upsampled and the projector's pixel grid (respectively, the input image) is upsampled the corresponding version is the original version of it. When it is referred to a version of the input image, or the projector's pixel grid, this does not necessarily imply a modification of it. The version may be the original version.

FIG. 6A illustrates an initial situation, similar to the situation in FIG. 5. Projector pixels repartition is more dense than the input image repartition.

In FIG. 6B, the input image is upscaled by a factor of 3.0. Thus, supplementary pixels are inserted in the original image so that the repartition of the upscaled input image is more dense.

The upscale factor is not restricted to integer values. Therefore, the input image pixels of FIG. 6A may not have corresponding pixels in the upscaled grid shown in FIG. 6B situated exactly at the same position. Furthermore, depending on the upscale method, even if a pixel in the upscaled grid shown in FIG. 6B has a position identical to a pixel of the input image shown in FIG. 6A, these two pixels may not have exactly the same colours. The blocking artifacts described with reference to FIG. 5 may be avoided by using such upscaling before the interpolation.

FIG. 6C illustrates nearest-neighbour interpolation performed for obtaining pixel colours of a grid having the same geometrical orientation as the grid of the projector pixels but being twice as dense. The interpolation thus results in an accordingly over-sampled version of the image to be displayed by the projector.

Then downscaling may be performed. As for up-scaling, the down-scaling factor is not restricted to integer values. Downscaling may generate a smooth image, wherein the “disappearing pixel” artifacts described with reference to FIG. 4 do not appear.

FIG. 6D shows the final stage after downscaling from the oversampled grid obtained during interpolation. Depending on the downscale method, even if a pixel in the downscaled grid shown in FIG. 6D has a position identical to a pixel of the oversampled grid shown in FIG. 6C, these two pixels may not have exactly the same colours.

FIG. 7 illustrates upscaling and downscaling according to embodiments of the invention. In the example shown in FIG. 7, the upscale factor is 12/8=1.5. Re-scaling is performed in the frequency domain on pixel blocks, for example square blocks.

Block 701 is an eight by eight (8×8) pixels block from the image to be upscaled (other block sizes are may be envisaged). Pixels of coloured images are generally composed of three components R, G and B representing the intensities in red, green and blue channel respectively. An alternative representation frequently used is YCbCr with a luminance component Y and two chrominance components Cb and Cr. In either representation, each of said three components is usually represented as an integer value with a predetermined number of bits—most commonly 8 or 12, allowing for values ranging from 0 to 255 or 4095 respectively. Each of the three colour components is processed separately.

From block 701, an 8×8 block 702 is obtained comprising DCT (Discrete Cosine Transform) frequency components. Block 702 has the same size as input block 701.

The frequency components are represented with horizontal spatial frequencies increasing from left to right and vertical spatial frequencies increasing from top to bottom, i.e. the top-left corner of the block contains the continuous component. The frequency components can be represented as floating-point numbers or rounded to signed integers—however, more bits are needed for representing the frequency components than the initial colour component values.

There exist efficient DCT algorithms processing n×n blocks with a time complexity of O(n²*log n).

From block 701, it is obtained a block 703 of, e.g., 12×12 components by extending it with padding coefficients (4 columns at the right and four rows at the bottom of block 701 in FIG. 7). The coefficients are set to zero and take the place of supplementary high frequency coefficients. Furthermore, in order to prevent “ringing” artifacts due to the Gibbs phenomenon, the original high-frequency components are successively attenuated by multiplying them with a predetermined coefficient as shown in the FIG. 7.

Other upscale factors than illustrated in the figure can be obtained by padding with a different number of zero-coefficient rows and columns—the granularity of the factor being ⅛ (generally 1/n when n×n is the input size of block 701). Furthermore, downscaling may be obtained through discarding highest-frequency components of block 702 instead of zero-padding. In such case, the filtering coefficients are accordingly adjusted.

Next, an IDCT (Inverse Discrete Cosine Transform) is performed on frequency block 703 in order to obtain a pixel block 704 of the targeted size (e.g. 12×12). Also, the pixel values may be scaled and clipped to the targeted range (e.g. from 0 to 255 or 4095).

DCT (or similar) transformations are used in video compression standards such as MPEG or H.264. If the video projector receives a video stream compressed according to such standards and unless the stream is also compressed using spatial prediction (among adjacent macro-blocks) or temporal prediction (among adjacent video frames), the incoming video data already is in form of frequency coefficients 702 after entropy decoding and de-quantization. Using such transformations may thus optimize the chain of processing by integrating the video decoding and up-scaling steps.

FIG. 8 schematically represents a functional architecture for a control apparatus or a video projector according to embodiments of the invention. For example control apparatus 130 and or video projectors 111, 112, 113 or 114 in FIG. 1 are designed according the functional architecture illustrated.

The functional control modules are grouped in a “calibration” module 800 and the video projector modules are grouped in the “video displaying” module 850 (or control unit).

First the calibration module is described.

Analysis module 801 analyses the photo (or the set of photos) of the projection screen acquired by a calibration camera (or several calibration cameras) in order to identify the points of interest such as the corners of the quadrilateral areas 201 to 223 in FIG. 2 illuminated by each projector.

A module 802 places the projection area 230 (shown in FIG. 2) and determines the borders 241 to 254 delimiting the image portions and the overlapping/blending zones attributed to the projectors.

Calculation module 803 determines the upscale factor and the downscale factor to be used by the projectors before and after the interpolation step. For example, the downscale factor is set to 2.0 while the upscale factor is variable and chosen so that that the ratio “number of pixels in the upscaled portion of input image per projector” by “number of pixels in the keystone-corrected image prior to downscaling” is close to 1:1 for all projectors. The pixel grid corresponding to the upscaled input image covers the whole projection area 230 and is hence common to all projectors i.e. each projector operates on a rectangular sub-grid from said common grid.

Calculation module 804 determines the geometric distortion correction (homography) for each projector, using the correspondences between the points of interest as described with reference to FIGS. 3A and 3B. The module takes into account both the upscaling and the downscaling factors in order to determine the nearest-neighbour interpolation relationship (as illustrated in FIG. 6C between the pixel grid corresponding to the upscaled input image and the oversampled pixel grid geometrically aligned with the projector's pixel grid.

Next, the video displaying module is described.

Extraction module 851 is in charge of extracting in each video frame the rectangular part of the input image (for example received through the data network 150) that the projector is in charge of displaying.

Upscale module 852 performs for each video frame the upscaling step using, for example, the algorithm described with reference to FIG. 7, with the upscale factor determined by module 803.

Blending module 853 performs blending in the image region overlapping with the image region from a neighbouring projector. For example, the module smoothly reduces the brightness towards the image borders from a maximal value to zero. Thus, the superimposition of the image projected by the neighbour projector (applying the blending in a complementary manner) results in constant brightness on the screen. The advantage of blending after, rather than before upscaling is smoother transition.

Block 854 performs nearest-neighbour interpolation from the up-scaled input image to the oversampled pixel grid geometrically aligned with the projector's pixel grid. For this purpose, a co-ordinate look-up table pre-calculated using the homography obtained from block 804 is used—see FIG. 4. During this step we also determine the zones in the projected image that have to remain black since they fall outside the image to be displayed.

Interpolation module 855 performs for each video frame the downscaling step using, for example, the algorithm described with reference to FIG. 7, with the downscale factor determined by module 803.

Projection module 856 is in charge of projecting the resulting image.

Modules 801, 802 and 803 may be provided in one single device whereas module 804 may be distributed between the projectors. Modules 851, 852, 853, 854, 855 and 856 may be distributed between the projectors and may be independent from each other. However, depending on the nature of the data network to which they belong (point-to-multipoint or point-to-point) and depending on the capabilities of the video source, the extraction module 851 may be implemented in the video source.

FIG. 9 illustrates a digital zoom functionality according to embodiments of the invention.

Digital zoom differs from optical zoom notably in that in optical zoom the dimensions of the projected image are changed by modifying the lens focal distance (resolution does not change) whereas in digital zoom, it is the image resolution that is changed. When zooming out above the resolution of the projector's grid, i.e. displayed image getting smaller, non-activated pixels of the projector's grid are set to the black colour.

The functionality is described in the context of a multi-projector system with six projectors are arranged in two rows and three columns. The rectangular projection image area 901 (which may also be referred to as a projection screen) is chosen to be the largest area fitting in the screen zone covered by the projectors and having the same aspect ratio as the input video image to be projected. Area 901 is comparable to area 230 in FIG. 2. The input video image is divided into video image portions, each image portion being processed by one video projector. We suppose that an upscale factor of 24/8=3.0 has been chosen for projecting the video on area 901—i.e. a pixel grid covering said area, having 3×3 times the number of pixels of the original input video.

It is assumed that the projectors have determined the mapping (look-up table) for performing nearest-neighbour interpolation from said pixel grid to its over-sampled pixel grid geometrically aligned to the projector pixel grid, as illustrated in FIG. 6C. It is also assumed that the resolution of the image associated with the input video image is chosen to be equal to the resolution of the projection image area 901, that is to say the resolution corresponding to all the set of 3 by 3 projectors.

In the context of FIG. 9, we suppose that a user wishes to shrink the display area, e.g. through repeatedly pressing a “Zoom −” button on a remote control 170. The control apparatus of the system then incrementally decreases the zoom factor in steps of ⅛ and causes all projectors of the system to synchronously apply the new digital zoom factor as well as to adjust the borders of the rectangular image chunk of the video image portion to be displayed by each projector. The pixels in the area outside the rectangular image chunk are set to black.

In case the digital zoom is performed relatively to a corner of the image area 901 (for example bottom left as shown in FIG. 9), the video image portions resulting from the division of the input video image need to be adapted according the zoom factor. However, and advantageously, in case the digital zoom is performed relatively to a central portion of the projection image area 901, re-division of the input video image between the different video projectors may not be performed.

Consequently, the input image is mapped to a partial rectangular sub-area of the aforementioned “up-scaled input grid” (the respective outside zones being considered as black). The figure shows some of such sub-areas: areas 902, 903, 904 and 905 corresponding respectively to upscale factors 16/8=2.0, 12/8=1.5, 9/8=1.125 and 8/8=1.0.

The digital zooming functionality may be simplified because there is no need to determine the coordinates of the interpolation pixel grids shown in FIG. 6C and the coordinate look-up table used for nearest-neighbour interpolation again.

Shifting the shrunken display area on the screen (e.g. if the user presses “U”, “D”, “L” or “R” buttons on remote control 170, corresponding respectively to “Up”, “Down”, “Left” or “Right”) may also be performed. Area 915 is an example of the shifted area 905.

The zoom − and shift functionalities let the user position the image to be projected according to his needs.

The user may also wish to enlarge the display area by pressing the “Zoom +” button. If the maximal area 901 is reached and the user continues to issue “Zoom +” commands, the upscale factor may be further incrementally increased by ⅛ steps beyond factor 24/8 while accordingly cropping the input image. The cropping window may be shifted within the input image e.g. when the user hits “U”, “D”, “L” or “R” buttons on remote control 170.

If only a small part of the full area 901 is used, not all projectors participate in projecting the image. For example, area 902 may be covered using only the four projectors A1, B1, A2 and B2; area 903 may be covered using only the two projectors A2 and B2 and finally areas 904 or 905 may be covered using only projector A1. In such a case, the unused projectors may pass in “energy save mode” (e.g. the projection lamp could temporarily be switched off). Blending with such unused projectors is disabled.

The digital zoom functionality has been described as an exemplary functionality applied synchronously by projectors of the system. Embodiments of the invention may provide other functionalities.

Implementations of synchronous configurations for the projectors according to commands are described in what follows, with reference to FIGS. 12 to 17.

Before describing these implementations, steps performed during calibration of a projection system according to embodiments of the invention are described with reference to FIG. 10 which is a general flowchart of such steps. For example, the steps are performed by a system as represented in FIG. 1.

During step S100, a calibration image (for example white, or grey) is projected on the projection screen. Next, a calibration camera acquires one or several pictures of the screen during a step S101.

Next, points of interest are detected in the projected image during step S102 (i.e. the corners of the quadrilateral zones illuminated by the projectors). The zone for image projection is then placed during step S103, taking into account source video aspect ratio as already discussed hereinabove.

The upscale and downscale factors are then determined during step S104. If downscale is not necessary, determination of this factor may be omitted. The factors may be determined for all the projectors of the system or each projector may have factors determined for it.

The factors may take into account DCT block sizes, so that the number of pixels in the upscaled input image is close to the number of pixels in the oversampled target image (or projector grid).

Next, during step S105, it is determined, for each projector, the zone within the source image that it has to display, together with the blending zones.

Also, during step S106, for each projector, it is determined the homography for compensating the projector's geometric distortion and the related mapping from the upscaled input image to the oversampled target image.

FIG. 11 is a general flowchart of steps performed during projection in a projection system according to embodiments of the invention. For example, the steps are performed by a system as represented in FIG. 1.

During step S110, the input image is upscaled by an upscale factor as determined during step S104. For example, upscaling is performed in the frequency domain using DCT.

Next, blending is performed during step S111 in the blending zones.

Interpolation, such as nearest-neighbour interpolation, is then performed during step S112, according to mapping determined during step S106.

Downscaling of the oversampled target image may be performed during step S113. Next, the image is displayed during step S114.

In case a zoom command is issued in step S115, a new upscale factor is determined during step S116 and the process goes back to step S110.

A computer program according to embodiments of the invention may be designed based on the flowcharts of FIGS. 10 and 11 and the present description.

Such computer program may be stored in a ROM memory of a device as described with reference to FIG. 8. It may then be loaded into and executed by a processor of such device for implementing steps of a method according to the invention.

In what follows, there are described implementations for management of commands (for example open stream, close stream, resize image, shift, brightness adjustment, contrast adjustment, colour adjustment, zoom etc.). Such commands may originate from a user. For example, le commands originate from a remote control.

The commands impact the image processing. For example, processing such as cutting, geometric distortion correction, scaling, edge blending, photometric adjustments, colorimetric adjustments, synchronization, or other types of processing may be needed.

In a multi-projection system, one or several projectors may be impacted. For example:
commands such as opening/closing streams, zooming and shifting may require changing the destination projectors to which the video stream in question is sent. Also, video cut, edge blending and scaling for geometric distortion correction may be affected. Changing the video cut performed by the source projector may require changing the amount of video data to be sent to each destination projector, and hence changing the network bandwidth use.
zoom-in/out and/or window resizing may require the initial video scaling factor to be changed. For example, an input video of 4k2k resolution is usually displayed with full resolution in a multi-projection system; however if a user wishes to zoom out the display window to a small size not allowing full-resolution display, the projector in charge of distributing the video stream among the remaining projectors involved in displaying can perform initial downscaling to reduce the network bandwidth consumption.
brightness, contrast and colour adjustment of a chosen display window or of all display windows may be carried out by all concerned destination projectors, while taking into account possible photometric and colorimetric adjustments necessary to compensate for respective differences between different projectors.
coordinated optical zoom, may require adjustment of cut, edge blending and geometric distortion correction, in a manner that is coherent with the screen size change (due to the lens focal length change) of the partial image displayed by each projector.

Commands received by any of the projectors in the multi-projection system need to be appropriately processed and the resulting changed image processing parameters have to be distributed to all concerned projectors. Furthermore, updating the image processing parameters impacted by each command needs to be coordinated between the source projector and all destination projectors in a timely synchronized manner, preferably using the given inter-projector network. For example, all projectors may apply a new setup at the beginning of the same video frame.

FIG. 12 shows an exemplary multi-projection system. Six video projectors 1201, 1202, 1203, 1204, 1205 and 1206 are represented (embodiments are not limited to six projectors; any other number may be used). The projectors are also designated with letters “A” to “F”. Each projector illuminates an area on a projection screen 1220 (delimited by a thick double line in FIG. 12). The projection screen may be planar. For example, the projection screen is rectangular. The areas illuminated may be convex areas. The areas may be quadrilateral areas. In FIG. 12, the areas are delimited by thin continuous lines. In FIG. 12, six areas (the same number as the number of projectors) 1221, 1222, 1223, 1224, 1225 and 1226 are represented. Said six areas are arranged in two horizontal rows and three vertical columns. Any other arrangement may be implemented. The border zones of the areas may overlap. They may overlap on purpose, in order to ensure seamless display.

The projection areas 1221 to 1226 may show projective distortions. For example the distortions may be due to the fact that the projectors' optical axes are not perfectly orthogonal to the projection screen. The distortion may also be due to mechanical tolerances in the mounting of the projectors.

The distortion may be observed by the fact that the illuminated areas are not rectangular. This may also be observed by the fact that the borders are not parallel to each other and/or to the borders of the projection screen.

The video projectors 1201 to 1206 may be interconnected through a high-speed network 1200. The network may be wired or wireless and the network topology may be bus-like (data sent by one of the projectors are received simultaneously to all other projectors) or meshed (composed of point-to-point links, wherein different source projectors may simultaneously transmit data to different destination projectors). Network 1200 provides bandwidth and low delay enough to cope with the transmission of compressed or uncompressed video data streams. For example, bandwidth and low delay are compatible with a resolution of up to 4k2k and a frame rate of up to 60 frames per second. The network may also be compatible with transmission of very high-resolution still picture data without tight real-time constraints.

Each one of the projectors 1201 to 1206 may have at least one video input and at least one digital data port configured for inputting pictures (for example still pictures). The video input may be analogic (composite, S-video, VGA, or other types) and/or digital (DVI, HDMI, DisplayPort, or other types). Digital data ports may comprise Ethernet, and/or USB, and/or Wi-Fi, and/or a memory card reader.

In FIG. 12, two video or still picture sources are represented (any other number of sources may have been represented): Source 1211 (“Source 1” and source 1212 (“Source 2”). Source 1 is connected to projector 1201 and Source 2 is connected to projector 1204. For example, the video sources send 4k2k (3840×2160) video streams at 60 frames/s, in uncompressed YCbCr format with a colour depth of 8 bits and chroma subsampling of 4:2:0. This corresponds to 12 bit per pixel, 8 294 400 pixels, a frame size of 12 441 600 bytes and a data rate of 5.97 Gbit/s.

During system installation or power-up, a calibration stage may be performed. For example, input data may be gathered for situating on the projection screen 1220 the maximal rectangular area suitable for image projection and for properly splitting the video image to be projected among the different video projectors, taking into account the overlapping as well as the geometric distortion. At this stage, at least one digital calibration camera (not shown in FIG. 12) may be used to take one or several photos of the whole screen 1220 with the six areas 1221 to 1226. In case screen 1220 is planar, one single photo may be taken while all six video projectors 1201 to 1206 simultaneously project each one a uniformly white or grey image. Said digital calibration photos are transferred to and analysed by at least one of the projectors 1201 to 1206. As a result of said analysis, the coordinates of the four corners of each one of the six quadrilateral areas 1221 to 1226 may be obtained in a suitable screen coordinate system. Other means, e.g. manual analysis, can also be used to obtain said coordinates. Furthermore, according to the camera perspective, the calibration photo may show a projective distortion—in this case, obtaining the required coordinates (known in the camera coordinate system) in the screen coordinate system may necessitate a geometric correction that can be determined e.g. using the screen borders, visible in the calibration photo, as a reference. Said coordinates are transmitted to the respective projectors 1201 to 1206 and stored for the purpose of determining the geometric distortion correction parameters. Other points of interest inside the area illuminated by a projector than the four corners of said area can be used for calibrating the geometric distortion correction function of the respective projector. Coordinates of four points of interest known both in screen coordinate system and the projector's pixel coordinate system enable the projector to determine the homography (e.g. in the form of a 3×3 matrix with real coefficients) correcting the geometric distortion induced by the projection. Analyzing calibration photos and performing the required calculations for obtaining said homography matrix may be performed according to techniques known to the skilled person. It may also be done as described above with reference to FIG. 3.

Knowing the coordinates of all corners of the quadrilaterals 1221 to 1226 in the screen coordinate system also allows the projectors to identify the maximal screen area 1231 (for example maximal rectangular screen area) suitable for multi-projection. This may correspond to the largest one of the rectangles marked by a thick dashed line in FIG. 12. The top border of area 1231 is determined by the bottom-most one of the top corners of the quadrilaterals 1221, 1222 and 1223. The bottom border of area 1231 is determined by the top-most one of the bottom corners of the quadrilaterals 1224, 1225 and 1226. The left border of area 1231 is determined by the right-most one of the left corners of the quadrilaterals 1221 and 1224. The right border of area 1231 is determined by the left-most one of the right corners of the quadrilaterals 1223 and 1226.

The projectors may determine the vertical edge blending zones 1227 and 1228 (vertically dashed in FIG. 12) and the horizontal edge blending zone 1229 (horizontally dashed in the figure). In the present example, the blending zones are rectangular. The vertical edge blending zones 1227 and 1228 occupy the full height of the (rectangular) area 1231; the left border of zone 1227 (respectively 1228) is determined by the right-most one of the left corners of the quadrilaterals 1222 and 1225 (respectively 1223 and 1226); similarly the right border of zone 1227 (respectively 1228) is determined by the left-most one of the right corners of the quadrilaterals 1221 and 1224 (respectively 1222 and 1225). The horizontal edge blending zone 1229 occupies the full width of the rectangular area 1231; the top border of zone 1229 is determined by the bottom-most one of the top corners of the quadrilaterals 1224, 1225 and 1226; similarly the bottom border of zone 1229 is determined by the top-most one of the bottom corners of the quadrilaterals 1221, 1222 and 1223. The horizontal and vertical edge blending zones intersect—these intersection zones are filled with a dotted grid in the figure.

It may be possible to define the edge blending areas 1227, 1228 and 1229 to be smaller than what is depicted as long as they fit within the given borders. A width or height may be about 20% of the width or height of the area covered by a single projector.

The borders of the vertical and horizontal edge blending zones divide the maximal possible display (rectangle) 1231 into fifteen smaller areas (rectangles in what follows) marked in the figure by the letters A to F or by combinations of these letters. The six rectangles marked A, B, C, D, E and F correspond to image zones to be displayed solely by one respective projector 1201, 1202, 1203, 1204, 1205 or 1206. The rectangles marked AB and DE lie in the vertical edge blending zone 1227; the rectangles BC and EF lie in the vertical edge blending zone 1228 and the rectangles AD, BE and CF lie in the horizontal edge blending zone 1229—the image zones situated in these seven rectangles are displayed each one by the two respective projectors (e.g. in rectangle AB by projectors 1201 and 1202). The rectangles marked ABDE and BCEF lie in the intersections of the vertical edge blending zones 1227 respectively 1228 with the horizontal edge blending zone 1229—the image zones situated in these two rectangles are displayed each one by the four respective projectors (e.g. in rectangle ABDE by projectors 1201, 1202, 1204 and 1205).

The video stream originating from Source 1 is distributed by projector 1201 over the network 1200 to the other projectors 1202, 1203, 1204, 1205 and 1206. All six video projectors display an aggregate, seamless image corresponding to the said video stream on the screen 1220, where the display window for said image is contained within the rectangular projection area 1231. For the sake of conciseness, we assume here that said display window exactly matches rectangle 1231. In a more general case, the aspect ratio of the source image (e.g. 16:9, 16:10 or 4:3) may be taken into account in order to situate the actual display window, with a matching aspect ratio, inside rectangle 1231.

Initially, the video stream originating from Source 2 is distributed by projector 1204 over the network 1200 to the other projectors 1201, 1202 and 1205 involved into displaying said video stream—the four projectors 1201, 1202, 1204 and 1205 display an aggregate, seamless image corresponding to the said video stream on projection screen 1220 within the display window 1232 (the smallest one of the areas delimited by a thick dashed line in FIG. 12).

The overall system of FIG. 12 is associated with a remote control 1250, for example, an infrared remote control. The remote control makes it possible to issue commands for the system, such as zoom commands or other types of commands.

Alternatively, or in combination, the commands may be issued with other means. For example, the commands may originate from any interface (buttons, graphical interface, communication ports, or other types) directly on the projectors or on the video sources. The interface may comprise a terminal or a dedicated control application executed e.g. on a PC or a smartphone, communicating with at least one of the projectors 1201 to 1206 e.g. through RS-232, USB, Ethernet or Wi-Fi, using TCP/IP or other well-known protocols.

Back to the remote control example, a zoom command (or any other type of command) is issued by the user and received by a projector, for example projector 1206. Any other projector may receive the command. For example, the command is received by the projector spatially closest to the remote control.

The command is associated with a modification of the size of the display window of the video stream originating from Source 2 in order to achieve the zoom. In this example, the window is enlarged to a new display window 1242. Display window 1231 is placed in the background and partially hidden by display window 1232 respectively 1242.

In order to display the new window, projectors 1201 to 1206 must reconfigure. The reconfiguration is made synchronously.

The data exchanges between the projectors and the associated synchronized update of video cut and blending parameters for implementing the zoom function (as illustrated in the figure for switch-over of the video stream originating from Source 2 from display window 1232 to display window 1242) in response to a command (such as a user command), which may be sent by a remote control is described is details in what follows.

FIGS. 13a and 13b show examples of timelines for video frame transmission and reconfiguration command transmission in network 1200. For example, the multi-projection system works at a frame rate of 60 frames/s which means that the data of each video frame has to fit in less than 1/60 s. The multiple video sources attached to the same or to different projectors may be genlocked so as to have their frame rates synchronized.

In FIG. 13a, data frames 1301, 1302, 1304, 1306, 1307, 1308, 1309 and 1310 represent successive video frames transmitted through network 1200 in respective dedicated time slots. In case the system comprises several video sources (connected to a same projector or to several projectors), each of said data frames may be subdivided into a number of parts corresponding to the number of sources (exemplary subdivisions are described with reference to FIG. 16).

Each one of the data frames 1301, 1302, 1304, 1306, 1307, 1308, 1309 and 1310 may comprise network packets, which may originate from several source projectors e.g. both projectors 1201 and 1204.

Network packets of a given data frame may be transmitted sequentially. They may also be transmitted simultaneously on different channels or physical links.

Initially all the projectors are configured according to the initial video source and screen layout e.g. the video originating from source 1211 is displayed in the background window 1231 and the video originating from source 1212 is displayed in foreground window 1232. Video cut and edge blending parameters are set accordingly. The data frames 1301, 1302, 1304, 1306 and 1307 comprise network packets containing video data sent by the source projectors 1201 and 1204. The projectors perform video cut on the video frames received from the respective video sources 1211 and 1212. Projector 1201 may not transmit the part of video data from source 1211 to be displayed in window 1231 that corresponds to the part of window 1231 that is hidden by window 1232. This may save network bandwidth.

During transmission of data frame 1302 over network 1200, a command is issued. For example, the command is issued by a user, e.g. with remote control 1250. The command is received by a receiving unit. The receiving unit may be comprised in a projector of the system, for example projector 1206.

Once the command received, a control unit associated with the receiving unit may identify the video stream (or the plurality of video streams) that is concerned by the command. For example, the control unit is comprised in the projector that has received the command. The identification of the video stream (or the plurality of video streams) may be performed with knowledge of the current video source and screen layout.

Next, the command is forwarded to the projector(s) associated to the streams (or plurality of video streams), e.g. projector 1204. For example, the command is encapsulated in data frame 1303 following data frame 1302.

More than one projector may receive the initial command. This may be the case when using a remote control, for example if the receiving units of the projectors operate with a same infrared channel. In such case, the projector which receives both the initial command and the forwarded command may eliminate the duplicate command(s). Duplicate commands may be detected e.g. based on the type of the command (e.g. associated with a same modification) and/or the reception time—for example if several commands of the same type are received within a predetermined short time interval, they are considered as the same command and hence taken into account only once. For example, only the command received in first is considered. Duplicate command may also be eliminated in case of receipt of a same command forwarded by several other projectors. In this case the type of command may include the fact that the command is forwarded or not—for example if several commands of the type forwarded and associated with a same modification are received within a predetermined short time interval (for example within 1 ms or 1 s), they are considered as the same command and hence taken into account only once. For example, only the command received in first is considered.

Once it received the command forwarded by projector 1206, projector 1204 decodes the command. Next, it may determine new parameters for executing the command. For example, it may determine the size and position on projection screen 1220 of the new display window 1242 that is to replace the display window 1232 for displaying the video stream originating from video source 1212. It may also calculate the new video cut and edge blending parameters.

Next, projector 1204 sends a reconfiguration command containing the new parameters. For example, the parameters are encapsulated in data frame 1305 following video data frame 1304, to relevant projectors in the system.

An acknowledgement mechanism (not depicted in FIG. 13a) may be provided for ensuring that all projectors in the network have received the reconfiguration command 1305 before executing it.

After receiving the reconfiguration command in data frame 1305, the projectors (including projector 1204 that sent said frame 1305) use the new parameters, (for example the new video cut and edge blending parameters) to determine the new video display configuration and the corresponding video data frame layout to be applied, starting from video data frame 1308.

The configuration updating process may comprise determination of the edge blending zones and the calculation of geometric distortion correction configuration. This may be the case, if the position or the size of the image part to display by a given projector, the number of input pixels in said image part and the density of said pixels change. The homography may be determined again, for mapping the projector's pixel coordinates into the pixel coordinate system of the input image part to be displayed (the geometric correction and image interpolation has been described with reference to FIGS. 1 to 11).

The configuration updating process may also comprise update (e.g. by the projectors) of the parameters of the (optional) initial image rescaling, the video cut and the corresponding routing of video data over network 1200. This update is described in details with reference to FIGS. 15 and 16. Accordingly, the projectors that are potential destinations for video data of a given video source (e.g. projectors 1202, 1203, 1204, 1205 and 1206 for the video stream originating from source 1211 and distributed over network 1200 by projector 1201; projectors 1201, 1202, 1203, 1205 and 1206 for the video stream originating from source 1212 and distributed over network 1200 by projector 1204) may be prepared to switch over to the new layout of video data frames to be applied beginning with frame 1308. The duration of the calculation to be carried out by all involved projectors before switching over to the new configuration may depend on the type of reconfiguration command. The duration is known by the projectors. The duration may be expressed in terms of number of video frames since the receipt of reconfiguration command 1305 (2 frames in the timeline depicted in FIG. 13a). For example, an indication of this duration can be contained in the reconfiguration command 1305.

During the calculation of the new configuration, the previous configuration continues to be applied by all involved projectors, as e.g. for video data frames 1306 and 1307. Video data frame 1308 is the first frame containing video data according to the new configuration applied by the source projectors 1201 and 1204 and all projectors in the system switch over to the new, previously prepared configuration beginning from this frame and for the subsequent frames 1309, 1310 etc. until a new command is issued.

The invention is not limited to user commands and zoom commands. Other types of commands may be executed. Exemplary commands may be coordinated optical zoom with appropriate adjustment of video cut and edge blending, shifting of display window 1232 within the maximal possible display rectangle 1231 on the projection screen 1220, adjusting the aspect ratio (anamorphous distortion) of a display window, lens focusing, image flipping, digital zoom-in with image cropping (and shifting the cropping window), adjusting the sharpness, brightness, contrast, gamma, saturation or colour balance either of the image being displayed in a selected display window or of all currently displayed images simultaneously, opening a new video stream or displaying a new still picture, closing the display window of a video stream or still picture, switching off or putting into energy save mode of all projectors in the system, image freezing or blanking, audio muting or volume control or maintenance and status queries (lamp age counter, temperature, error status).

The processing performed by the projectors may depend on the type of command issued.

Some commands may affect the geometric display screen layout and consequently the initial scaling, video cut, edge blending and video data frame layout and routing over network 1200 to be done by the relevant source projectors. This may be the case for e.g. display window zooming and shifting, digital zoom-in, opening and closing display windows, coordinated optical zoom, aspect ratio adjustment or image flipping. This may not be the case for, e.g., adjusting the brightness, contrast, gamma, saturation or colour balance.

Some commands may affect the display solely by adjusting the digital image processing while others act additionally or exclusively through other means. This may be the case for, e.g., actuating the optical zoom, image dimming through adjusting the lamp power or closing the lens diaphragm, power save or power off mode.

Some commands may not require any centralized processing (translation into configuration parameters) by a source projector or any elimination of duplicates (e.g. power off). For example projector 1206 receiving the command can forward the command, in association with a synchronization element, directly to all projectors in data frame 1303 (i.e. without need for sending a second reconfiguration command 1305) triggering an immediate reaction by all projectors.

Some commands affecting several video streams at once (e.g. global photometric or colorimetric adjustment) may require projector 1206 to forward the command to more than one source projector (e.g. both to 1201 and 1204) through command data frame 1303.

FIG. 13b illustrates a case wherein the data contained in the reconfiguration command frame 1355 do not fit in a timeslot concurrently with a video data frame (the case is different from the case illustrated in FIG. 13a for command 1305 sent in the same time slot as video data frame 1304).

In the present case, frame 1355 sent by the video source projector (e.g. 1204) may replace a video data frame sent by said projector (if the video data frame is composed of video data originating from different sources, e.g. from source 1212 attached to projector 1204, a partial replacement, concerning only the video data from source 1211, may be performed by projector 1201). The destination projectors may apply concealment techniques (as displaying again the previous video frame that was transmitted in data frame 1354) to cope with the resulting frame loss.

Reconfiguration commands containing even more data, not fitting within a single timeslot, can be split over several data frames, transmitted in a manner interleaved with the video data frames, replacing for example every other of the latter. Otherwise, the management by the projectors of the command data frames 1353 and 1355, the video data frames according to the old configuration 1351, 1352, 1354, 1356, 1357 and the video data frames according to the new configuration 1358 and 1359 (all these frames transiting on network 1200) are analogous to the management of the respective data frames 1301 to 1309 described with reference to FIG. 13a.

Methods according to embodiments of the invention are described hereinafter. Embodiments may comprise a method of processing image data for projection on a projection screen by a plurality of projectors projecting respective image portions of an image, the method comprising the following steps:
receiving a first command associated with a modification of at least one portion of said image, and
transmitting a second command for synchronous action to a first set of control units, based on the first command, said second command enabling said first set of control units to synchronously perform at least one action, by at least one projector of the plurality, in order to carry out said modification.

Thus, a command for a modification of a projected image may be performed by a plurality of projectors in a seamless manner. Each projector of the multi projection system may act in order to carry out the modification in a synchronized manner. Therefore, display of the overall image is not perturbed by the application of the modification.

The control units may be embedded in the projectors. They may also be part of separated devices connected to the projectors.

The second command may comprise the first command and a synchronization element for performing the at least one action in synchronization.

The action may comprise the execution of the modification. The action may also comprise configuration of parameters.

Thus, the method may further comprise determining, according to said modification, at least one projection parameter for said at least one image portion of the image, and wherein said action comprises a projection configuration based on said at least one projection determined parameter.

The at least one determined parameter may be transmitted to said first set of control units.

Thus, the control units may use the parameter for their own configuration. The parameter transmitted may be considered as an external information needed for execution of the at least one action.

The first set of control units may be determined as comprising the control units associated to projectors whose projection is affected by said determined parameter.

Thus, it may be avoided to transmit the second commands to all control units in the systems, thereby saving communication resources.

The first command may originate from a user. The user can be a process, a computer program or a device. In case the user is a person, a remote control or any other interface may be used.

The first command may be a forwarded command, forwarded by a control unit having received the command from a user.

The synchronous configuration may be based on an event detectable by said first set of control units.

For example, the event is indicated in said second command.

The event may take into account a type of processing needed for the configuration of the projection, by at least one projector of the plurality, of said at least one portion of the image, according to said modification.

Thus, the control units may have enough time to prepare for the execution of the action.

The event may take into account a transmission delay for transmission of said second command.

The event may be a time-based event.

The event may be a video frame-based event.

For example, the second command is transmitted by encapsulation into a video frame.

Thus, the event can be associated with a number of video frames starting from the video frame comprising the second command.

The method may comprise performing at least one action, in order to carry out said modification, in synchronization with the set of control units.

Thus, a control unit receiving the first command does not have to transmit the second command to itself.

The method may further comprise:
receiving at least one third command for synchronous action, for synchronously perform at least one action, by at least one projector of the plurality, in order to carry out the same modification as the modification associated with the first command, and
performing at least one action, in order to carry out said modification, in synchronization with the set of control units based on a synchronization element selected among synchronization elements respectively associated with said second and at least one third command.

Thus, conflicts that may appear when several control units receive simultaneously a same first command may be solved.

The synchronization elements may be associated with respective event, and the selected synchronization element may be the one associated with the event occurring the latest.

Thus, the safest event is selected, i.e. the one the occurrence at which, all the control unit are ready for executing their respective actions.

The method may comprise monitoring the event.

The method may comprise a step of preparation of said at least one action.

The preparation may comprise configuring according to a parameter determined.

The step of preparation of said at least one action may be performed after checking whether said preparation is needed, based on the modification associated with the first command.

Some modifications may or may not require preparation, thus, the preparation step may be ignored according to the modification to be carried out.

The step of preparation of said at least one action may be performed based on external information relating to at least one another control unit of another projector of the system.

This may be the case when an action to be performed by a control unit affects projection by a projector associated with another control unit. This may the case, for example, zoom commands which may affect blending.

The external information may obtained from said at least one another control unit of another projector of the system

The external information may comprise a parameter determined by another control unit. The external units may transmit the external information when the information is ready at their sides.

The external information may be obtained by performing calculations. Thus, there is no need to receive the information from other control units.

The external information may be obtained after checking whether said external information is needed, based on the modification associated with the first command.

Thus, the obtaining step may be ignored in case the actions by each control unit do not affect the projections of projectors associated with other control units.

The first command may comprise at least one of:

a digital zoom;
an optical zoom;
an image shifting;
a brightness control;
a colour control.

The at least one projection parameter may comprise at least one of:

a rescaling parameter,
an image cut parameter;
an image data routing parameter;
an upscaling parameter;
a downscaling parameter;
an interpolation parameter.

FIG. 14a is a flowchart of steps of a general embodiment. The steps described may be performed by a control unit associated with a projector of a multi projection system.

Step 1400 is a waiting step during which, the control unit associated with a projector waits for receipt of a command.

During step 1401, a first command is received. The first command may originate from a user (e.g. using a remote control), or a device or process. The first command may also originate from another control unit of another projector of the multi projection system. Thus the first command may also be a forwarded command.

The first command is associated with a modification of an image portion of the projected image. In order to perform the modification, one or several actions may be carried out by one or several projectors (or the associated control units). The action may be a configuration or a reconfiguration of the projection. The action may also be the execution of the command itself without need for further configuration or reconfiguration. Other types of actions may be envisaged.

Once the first command is received, a second command is generated during step 1402. The second command is associated with a synchronization element. The synchronization element enables the recipient of the second command to perform an action, for carrying out the modification, in a synchronous manner. The synchronization element may be embedded in the second command. The synchronization element may identify a frame, a time, an event or another element for identifying a moment at which the action should be performing. The synchronization aims at having the projectors involved in the modification to act so as to modify their respective part of the image portion in synchronicity.

Once the second command generated, it is transmitted, during a step 1403, to one or several other control units of projectors involved in the modification of the image portion. A step for identifying the one of several other control units may be performed before transmission.

Next, the control unit of the projector (that transmitted the second command) prepares for executing an action for performing the modification required in the first command. For example, it may apply new image parameter, update image parameters or perform other preparatory processes.

Step 1404 it followed by a synchronization step during which, the synchronization element is used for triggering the action to be executed. For example, it is waited for an event to occur, such as a time to elapse or number of frames to be received since the receipt of the second command etc.

Once synchronization is performed, the action is executed in step 1406.

The process then goes back to step 1400.

When the second command is transmitted during step 1403, it is received by another projector or by a control unit associated with it. Receipt of the second command is performed in step 1407. Once the second command is received, steps 1404, 1405 and 1406 are performed.

In case, two (or more) control units receive the same first command, a conflict may appear if they generate second commands with respective synchronization elements which are not the same. For example, a control unit may decide that the actions have to be executed at a time t1 and another control unit may decide that the actions have to be executed at a time t2 different from time t1. Since the second commands with different synchronization elements are all forwarded to the relevant projectors, the relevant projector may not execute their respective actions in synchronization.

In order to solve the conflict, it may be decided that among the commands associated with a same modification and with different synchronization elements, only the command with the synchronization element relating to the latest execution time of the action(s) is considered. For example if t2 is later than t1, the command associated with t2 is considered and not the command associated with t1.

This discarding process may be performed on commands received in a same interval of time, in order to allow a same modification to be performed several time during the operation of the multi projection system.

FIG. 14b is a flowchart of steps of a general embodiment. FIG. 14b shows how the type of modification required in the first command can trigger specific additional processing.

The steps in common with the flowchart of FIG. 14 have the same references.

Once the second command is transmitted or received in steps 1403 and 1407, it is checked during a step 1408 whether configuration of parameters is needed. This may depend on the type of modification required in the first command.

For example, commands may not require a centralized processing (e.g. translation into configuration parameters, possibly involving knowledge about the current global system configuration). The projector (or the associated control unit) receiving the first command, e.g. projector 1206, can forward it to all other projectors in the system using a single data frame inserted into the stream of video frames, triggering a synchronized reaction by all projectors.

For example, switching off the projectors does not require calculations of image parameters, but only stopping projection of images.

Other examples of such “simple” commands include “power off”, “stand-by”, “video blanking”, “video freeze”, “audio mute”, “audio volume control”, “global brightness” etc.

Other types of commands may require specific processing, such as updating image parameters (zoom commands for example).

Back to the flowchart, in case configuration is needed (yes), it is then checked whether preparation of the action to perform, e.g. including the configuration itself, required external information, e.g. information concerning the other projectors (or the associated control units). For example, for a zoom command, new blending may have to be performed based on the new parameters of the other projectors.

In case external information is needed (yes), a step 1410 is performed for obtaining such information. The information may be received from the other projectors. The information may be determined by the control unit performing the process. For example, with knowledge of the modification to be performed and the arrangement of the image portions associated with each projector, the control unit may determine the parameters update that each control unit associated with each projector performs.

Next, steps 1404, 1405, and 1406 are performed. In the present example, the preparation performed in step 1404 is a preparation of the configuration determined as needed in step 1408.

During steps 1408 and 1409, in case the configuration and/or the external information is not needed (no), the process directly goes to step 1404.

FIG. 15 is a flowchart of steps that may be performed for executing commands according to embodiments of the invention. The steps may be performed by control units respectively associated with the projectors of a multi-projection system. The control units may be comprised in the projectors or be comprised in distinct devices connected to the projector. Communication units may be used for exchanging the data discussed hereinafter. The communication units may be comprised in the projectors or be comprised in distinct devices connected to the projectors.

Step 1500 is a waiting step during which, the control unit associated with a projector waits for one of three possible events:
the receipt (step 1501) of a command (an initial command, i.e. not forwarded by another control unit associated with another projector),
the receipt (step 1511) of a command forwarded from another projector,
the receipt (step 1521) of a reconfiguration command from a control unit associated with a source projector of a video stream (sent in step 1513 described hereinafter), containing new video stream configuration parameters.

Receipt (1501) of a command is followed by a step 1502 of identification of the relevant video streams or still pictures concerned by the command.

For example, a command may solely concern the video stream displayed in a window previously selected, or all streams that are currently being displayed. This may be the case for commands affecting the photometric or colorimetric rendering (brightness, contrast, gamma, white balance etc.).

Some types of commands may affect both the given video stream or still picture and all the video stream(s) or still picture(s) currently displayed in background windows that are to be hidden or to be uncovered by the foreground display window. This may be the case for a command for opening a new video stream or still picture from a source attached to any one of projectors 1201 to 1206 in a new window, a command for shifting or resizing an existing display window or a command for closing a video stream or still picture and its associated display window (e.g. resizing foreground display window 1232, associated to video source 1212 attached to source projector 1204, to window 1242 will affect the display of video source 1211 attached to source projector 1201 and displayed in background window 1231).

However, management of such situation may be centralized in the source projector of the stream displayed in the foreground window.

During step 1503, all the source projectors (i.e. the projectors in charge of forwarding video or still picture data from an external source over network 1200, e.g. projector 1201 for the stream from source 1211) of said video streams are identified.

The projector having received the user command (e.g. 1206) forwards said command during step 1504. For example, the command is encapsulated in a data frame (frame 1303) sent over network 1200. The command is forwarded to all relevant source projectors. For example, for the window resizing shown in FIGS. 12 and 15, the command is forwarded to projector 1204.

If the projector that has received the command is a relevant projector, it doesn't need to forward the command to itself. However, the projector processes the command for execution of the modification associated with. Test 1505 is performed for determining whether the projector belongs to the set of projectors relevant for executing the command. In case it does not belong to the set (no), the process goes back to step 1500. Alternatively (yes), step 1512 is performed.

Step 1512 also follows step 1511 of receipt of a forwarded command (for example in a frame 1303) during step 1504.

During step 1512, new video stream (or still picture) parameters are determined. Duplicated commands (e.g. due to more than one projector receiving the same infrared command from the remote control 1250) may also be detected and eliminated during this step.

The determination of new stream parameters may depend on the command type. For example, in case of opening a new stream or still image, a default size and placement of the associated display window on the projection screen may be chosen (e.g. the maximum possible window having an aspect ratio matching the video or still picture to display, with a centred position). Another example is the shifting or resizing of a display window. The new size and position may be determined according to the current one, for example by using a predetermined step width. Once the new display window size and position have been determined (in the example of FIGS. 12 and 15, window 1242 replacing window 1232), the new initial downscaling, video cut and edge blending parameters may be determined (as described with reference to FIG. 15 for example). Other kinds of commands, e.g. photometric or colorimetric adjustments, don't impact video cut or edge blending but rather affect the other relevant settings of individual destination projectors. In any case, the source projector (e.g. 1204) sends the reconfiguration command representing the new stream parameters (and if applicable, also the new video data frame layout applicable for frames 1308, 1309, 1310 etc.) to all relevant destination projectors and also to the other source projectors which display windows are affected by the new configuration (in case of the reconfiguration described with reference to FIGS. 12 and 15, to projector 1201 in charge of source 1211 displayed in background window 1231). The reconfiguration command may be encapsulated in command data frame 1305 and inserted into the stream of video data frames originating from source 1212 and forwarded by source projector 1204, as presented in FIG. 13a. For sending frame 1305 to the other projectors, broadcast is used if network 1200 supports it; otherwise frame 1305 may be replicated (or possibly filled with target specific content) for each target projector.

Next, step 1514 is performed for preparing the new video configuration. For the source projector 1204 this preparing step may include preparing the new initial downscaling, video cutting and video data frame layout (comprising addressing and routing the data to the relevant destination projectors). Furthermore, if projector 1204 participates itself in displaying the video stream, it prepares the new image interpolation (for example through recalculating the coordinates of each projector pixel in the coordinate system of the image zone to project for each video source) taking into account the geometric distortion parameters that have been acquired on system setup and calibration, as well as the video cut and edge blending parameters determined. In case of a command affecting photometric or colorimetric image rendering (e.g. brightness, contrast, gamma, white balance etc.), video cut, edge blending zones and network frame layout are not affected; however the digital image processing parameters or other parameters (e.g. lamp power, optical zoom etc.) affecting said rendering have to be adjusted, in a manner maintaining possible projector-specific adjustments accounting for differences between projectors. In order to save computation time and/or in order to avoid disrupting a current video projection, the aforementioned calculations may be carried out in parallel with on-going data transmission and video projection according to the previous configuration

Next, during step 1515, synchronization with the other projectors is performed. It is waited for an event to occur for applying, during step 1516 the new parameters for executing the command. The event may be the sending of a predetermined number of time slots dedicated to video data frames (e.g. from the sending of command data frame 1305 in step 1513, e.g. frame 1306 and 1307). Other type of events may envisaged, e.g. timers.

During step 1516, all relevant parameters are updated. The parameters may concern, e.g., the control of lamp power, lens diaphragm, lens optical zoom, power saving etc. New parameters, determined during step 1514 may also be applied.

After step 1516, the process may go back to step 1500.

Upon receipt of a reconfiguration command in step 1521 (as sent by another projector in step 1513, for example in a data frame 1305), preparation of the new configuration is performed during step 1524. This step corresponds to step 1514 described above. Next, steps 1525 and 1526, respectively corresponding to steps 1515 and 1516 are performed and the process may go back to step 1500.

FIG. 16 is an illustration of a command that may be processed according to embodiments of the invention. FIG. 16 more specifically illustrates an exemplary picture-in-picture display with video cut parameters that change in response to a user-issued display window zoom command. It shows a more detailed view of screen 1220 in FIG. 12 (zones 1221 to 1226 are omitted). The edge blending zones 1227, 1228 and 1229, the background display window 1231, the foreground display windows 1232 and 1242 (before respectively after the zoom command) and the fifteen screen zones associated with edge blending and labeled by the letters A to F or combinations thereof have already been presented with reference to FIG. 12. FIG. 16 additionally shows:
In bold font, the x coordinates of the borders of the vertical edge blending zones 1227 and 1228 (‘1123’ to ‘1543’ respectively ‘2270’ to ‘2690’) the y coordinates of the horizontal edge blending zone 1229 (‘960’ to ‘1255’) and the x and y coordinates of the vertical respectively horizontal borders of the display windows 1231, 1232 and 1242 (‘0’ to ‘3840’ by ‘0’ to ‘2160’, ‘192’ to ‘1728’ by ‘840’ to ‘1704’, respectively ‘96’ to ‘3168’ by ‘240’ to ‘1968’). The coordinate system is the pixel coordinate system of the 3840×2160 image originating from video source 1211 that is to be displayed in the background window 1231 and forwarded over network 1200 by projector 1201.
In reverse-video font, the x coordinates of the borders of the vertical edge blending zone 1227 (‘1164’ to ‘1689’), the y coordinates of the horizontal edge blending zone 1229 (‘150’ to ‘519’) and the x and y coordinates of the vertical respectively horizontal borders of the display window 1232 (‘0’ to ‘1920’ by ‘0’ to ‘1080’). The coordinate system is the pixel coordinate system of the 1920×1080 image obtained through initial downscaling by projector 1204 of the 3840×2160 image originating from video source 1212; said downscaled image is to be displayed in the foreground window 1232. The initial downscaling is performed because the display window 1232 is relatively small with regard to the display resolution offered by the projectors, hence severe downscaling will be applied anyway during image interpolation for geometric distortion correction. Initial downscaling by projector 1204 makes it possible to reduce the bandwidth usage over network 1200; furthermore it prevents from losing pixel information due to image interpolation wherein each projector pixel's color is being determined only from the colors of a limited number of neighboring input image pixels (said number equals ‘1’, ‘4’ or ‘16’ for interpolation methods which are respectively nearest-neighbor, bilinear or bi-cubic interpolation).
In italic font, the x coordinates of the borders of the vertical edge blending zones 1227 and 1228 (‘1284’ to ‘1809’ respectively ‘2718’ to ‘3243’), the y coordinates of the horizontal edge blending zone 1229 (‘900’ to ‘1269’) and the x and y coordinates of the vertical respectively horizontal borders of the display window 1242 (‘0’ to ‘3840’ by ‘0’ to ‘2160’). The coordinate system is the pixel coordinate system of the 3840×2160 image originating from video source 1212 that is to be displayed in the foreground window 1242, said window being big enough not to justify anymore an initial downscaling by projector 1204.

Annex A is a table presenting the size in pixels of the different display windows 1231, 1232 and 1242, split among the fifteen screen zones (labelled by letters A to F and combinations thereof) determined by the edge blending areas 1227, 1228 and 1229, with the table columns corresponding to:
Background display window 1231 associated with video source 1211 to be distributed over network 1200 by the source projector 1201 (A), excluding the area hidden by the foreground window 1232, prior to receiving the user zoom command. Note that zone ABDE is empty since it is entirely hidden by window 1232; furthermore zone A doesn't need to be retransmitted on network 1200 since its display is solely taken in charge by projector 1201—for this reason it is marked in strike through font in the table.
Foreground display window 1232 associated with video source 1212 to be distributed on network 1200 by the source projector 1204 (D) after the initial downscaling from 3840×2160 to 1920×1080 performed by projector 1204, prior to receiving the user zoom command. Note that zones BC, C, BCEF, CF, EF and F are empty since they lie entirely outside window 1232; furthermore similarly as above, zone D is not retransmitted over network 1200 since its display is solely taken in charge by projector 1204.
The total of these two columns, taking into account only the pixels that need to be retransmitted on network 1200,
Background display window 1231 associated to video source 1211 to be distributed on network 1200 by the source projector 1201 (A), excluding the area hidden by the foreground window 1242, after receiving the user zoom command (note that zones ABDE, BE and BCEF are empty since they are entirely hidden by window 1242; furthermore zone A doesn't need to be retransmitted on network 1200 since its display is solely taken in charge by projector 1201),
Foreground display window 1242 associated to video source 1212 to be distributed on network 1200 by the source projector 1204 (D) without initial downscaling performed by projector 1204, after receiving the user zoom command (similarly as above, zone D is not retransmitted over network 1200 since its display is solely taken in charge by projector 1204),
The total of the last two columns, taking into account only the pixels that need to be retransmitted on network 1200.

At the bottom of the table, are given the total number of pixels transiting over the network, the size of the part of the video frame transiting on said network in Mbyte (supposing uncompressed transmission, a color depth of 8 bits, an YCbCr colour space and a chroma subsampling of 4:2:0, resulting in a data quantity of 12 bits or 1.5 bytes per pixel) and the resulting network bandwidth in Gbit/s (supposing a frame rate of 60 frames/s) for two cases:
A network of broadcasting or bus type with a medium shared between all source projectors and with ability to address network packets of video data frames to chosen individual projectors as well as to chosen sets of projectors (multi-cast facility). For example source projector 1201 needs to send video data representing the screen zone BCEF (hence to be displayed by projectors 1202, 1203, 1205 and 1206) only once. Data not to be retransmitted on network 1200 because it is processed only by the respective source projectors 1201 and 1204 (A respectively D) and marked in strike through font in the table, is not included into the totals.
A network 1200 comprising point-to-point links between any two of the projectors 1201 to 1206. For example source projector 1201 needs to send video data representing the screen zone BCEF (hence to be displayed by projectors 1202, 1203, 1205 and 1206) and has to replicate these data four times, resulting in appropriately higher aggregate bandwidth use on the network as the total takes into account the data replication. Data not to be retransmitted on network 1200 or to be replicated less often than the cardinality of the destination set, because the respective source projector 1201 or 1204 (A respectively D) is part of the destination set (and marked in strike through or italic font in the table), is not included into the totals.

The calculation of video data frame size and network bandwidth may be generalized to the case of other resolution, aspect ratio, color depth, chroma subsampling, image compression or frame rates, even if said parameters differ among different video sources. In particular, if one of the sources delivers still pictures, the resolution can be considerably higher than for video streams and the bit rate can be freely adapted (spreading the data transmission over several video frame timeslots) as a function of the available bandwidth over network 1200.

FIG. 16 is an illustration of exemplary video data frame layouts, changing in response to a display window zoom command, in case the network is of bus type, e.g. the transmission medium is shared among all transmitting projectors 1201 and 1204, and all projectors receive exactly the same data broadcasted on the network. Consequently the given frame sizes in pixels and megabytes reflect the “broadcast” case of Annex A for display windows 1231 and 1232 before respectively 1231 and 1242 after the zoom command issued by the user.

A video data frame prior to taking into account the zoom command (frames 1301, 1302, 1304, 1306, 1307 in FIG. 13a), sent in a timeslot of 1/60 s, is subdivided into:
part 1701, containing the video frame data to be displayed by the projectors 1202, 1203, 1204, 1205 and 1206 (zones AB, B, BC, C, AD, BE, BCEF, CF, D, DE, E, EF and F) in background window 1231, originating from video source 1 (1211) broadcasted over network 1200 by projector 1201, excluding both zone A that is displayed solely by projector 1201 directly and the zone that is hidden by the foreground window 1232.
part 1702 containing the video frame data to be displayed by projectors 1201, 1202 and 1205 (zones A, AB, B, AD, ABDE, BE, DE and E) in foreground window 1232, originating from video source 2 (1212) broadcasted by projector 1204, excluding the zone D that is displayed solely by projector 1204 directly.

A video data frame after taking into account the zoom command (frames 1308, 1309, 1310 in FIG. 13a), sent in a timeslot of 1/60 s, is subdivided into:
part 1711, containing the video frame data to be displayed by projectors 1202, 1203, 1204, 1205 and 1206 (zones AB, B, BC, C, AD, CF, D, DE, E, EF and F) in background window 1231, originating from video source 1 (1211) broadcasted over network 1200 by projector 1201, excluding both zone A that is displayed solely by projector 1201 directly and the zone that is hidden by the foreground window 1242.
part 1712 containing the video frame data to be displayed by projectors 1201, 1202, 1203, 1205 and 1206 (zones A, AB, B, BC, C, AD, ABDE, BE, BCEF, CF, DE, E, EF and F) in foreground window 1242, originating from video source 2 (1212) broadcasted by projector 1204, excluding zone D that is displayed solely by projector 1204 directly.

Depending on the characteristics of network 1200 (for example maximal network packet size, routing and addressing capabilities), each one of the video frame data parts 1701, 1702, 1703 and 1704 may be further subdivided into network packets, addressed to individual target projectors or groups of projectors according to the fifteen screen zones in FIG. 16.

Devices and systems according to embodiments of the invention are configured for implementing methods as described hereinabove. For example, such device for processing image data for projection on a projection screen by a plurality of projectors projecting respective image portions of an image, may comprise a control unit configured for receiving a first command associated with a modification of at least one portion of said image, and for transmitting a second command for synchronous action to a first set of control units, based on the first command, said second command enabling said first set of control units to synchronously perform at least one action, by at least one projector of the plurality, in order to carry out said modification.

The control unit may be configured for implementing any other step described herein above . . . .

A video projection system according to embodiments of the invention may comprise:
at least one device as described hereinabove, and
at least one projector for projecting images processed by the device on a projection screen.

The at least one projector may embed the control unit of said device.

The system may further comprise a remote control for issuing the first command.

It may also comprise a device configured for receiving the second command and synchronously executing the at least one action.

The at least one projector may embed the control unit of said device configured for receiving said second command and synchronously executing said at least one action.

FIG. 18 is a functional diagram of a device 1800 (such as a projector device) according to embodiments of the invention. The elements represented in FIG. 18 are comprised in a single device, however, other embodiments may be envisaged, wherein one or several elements are distributed in one or several distinct devices.

The device comprises at least one input 1801 which may be an analogic video input (e.g. composite, S-video, VGA, etc.), a digital video input (e.g. HDMI, DVI, DisplayPort, etc.), or a digital input for still pictures (e.g. Ethernet, USB, Wi-Fi, memory card reader, etc.). Incoming data from input 1801 are received by an interface unit 1802. The interface unit performs a selection of one or several video sources according to a configuration a configuration determined by a control unit 1809. The interface unit can also provide the control unit with information concerning the available videos or still pictures (e.g. resolution, color depth, chroma subsampling, frame rate etc.). The video stream or still picture stream is then processed by a downscaling unit 1803, configured by control unit 1809 to apply initial downscaling in case of mismatch (in particular large mismatch) between the resolution of the input video or picture and the available display resolution, taking into account the display window size determined as explained with reference to FIG. 16. Next, the video or still picture data are processed by the video cut and merge unit 1804. This unit is capable of processing video or picture data from the network interface unit 1808 in order to merge them prior to presenting them to unit 1805. Unit 1804 is also capable of performing the video cut explained hereinabove in order to send a part or all of the video data to unit 1808 instead of unit 1805. Video cut and merge unit 1804 acts following the configuration instructions concerning the cut positions given by control unit 1809. Unit 1804 is synchronized by unit 1809 to present video frame data to units 1805 or 1808 in due time. The geometric and photometric adjustment unit 1805, configured by unit 1809, carries out geometric distortion correction, edge blending and other digital photometric or colorimetric adjustments, prior to transmitting the video data to the display unit 1806. Unit 1806 controls the projector's light valve (typically an LCD, LCoS or DLP unit).

The inter-projector network interface unit 1808 interfaces the projector with the wired or wireless high-speed link 1807 being part of the inter-projector network 1200. It is capable of sending and receiving both video data frames like for example 1301, 1302, 1304, 1306, 1307, 1308, 1309 and 1310 (from or to unit 1804) and control data frames like for example 1303 and 1305 (from or to unit 1809). It is able of managing video frame display time synchronization with unit 1809; furthermore it is configurable by unit 1809 for addressing and routing within network 1200 of data frames.

The control unit 1809 is the central functional block for implementing the present invention, executing for example steps described with reference to FIG. 14 and managing configuration and synchronization of the remaining control blocks. Control unit 1809 may comprise a processor with dedicated RAM working memory, executing instructions, of a computer program with instructions for implementing a method according to embodiments of the invention. The computer program may be stored (e.g. as firmware) in a ROM memory. The control unit 1809 may also communicate through a suitable bus or internal control links with the other control blocks of the projector.

The control interface 1810 processes the communication with the user through the control link 1811. Control link 1811 may represent the infrared input from a remote control 1250. An alternative user input interface may be the projector's button panel. In these two cases, output may be presented to the user through on-screen pop-up menus. Other possible user interfaces comprise a terminal or a dedicated control application running, e.g., on a PC or a smartphone, in which case the control link 1811 may be, e.g., a USB link, an RS-232 link or a TCP/IP connection over Ethernet or Wi-Fi.

Unit 1812 represents miscellaneous projector functions controllable from unit 1809, that possibly affect the image display on the screen without intervening in the digital image processing performed by units 1802, 1803, 1804, 1805 and 1806 described above. These projector functions comprise the control of lamp power, of lens diaphragm, of lens focal length (optical zoom), of power save mode or power-down etc.

A computer program according to embodiments of the invention may be designed based on the flowcharts of FIGS. 14a, 14b, and 15 and the present description.

Such computer program may be stored in a ROM memory of a device as described with reference to FIG. 18. It may then be loaded into and executed by a processor of such device for implementing steps of a method according to the invention.

While the invention has been illustrated and described in detail in the drawings and foregoing description, such illustration and description are to be considered illustrative or exemplary and not restrictive, the invention being not restricted to the disclosed embodiment. Other variations to the disclosed embodiment can be understood and effected by those skilled in the art in practicing the claimed invention, from a study of the drawings, the disclosure and the appended claims.

In the claims, the word “comprising” does not exclude other elements or steps, and the indefinite article “a” or “an” does not exclude a plurality. A single processor or other unit may fulfill the functions of several items recited in the claims. The mere fact that different features are recited in mutually different dependent claims does not indicate that a combination of these features cannot be advantageously used. Any reference signs in the claims should not be construed as limiting the scope of the invention.

### ANNEX A

Pixel sizes after video cut of different display windows according to FIG. 16:

| | | Before Zoom command | | | After Zoom command | | |
|---|---|---|---|---|---|---|---|
| | | Source projector: | | | | | |
| | | A | D | | A | D | |
| | | Display window | | Total | Display window | | Total |
| Target projectors | | 1231 | 1232 | pixels | 1231 | 1242 | pixels |
| | A | | 174600 | 174600 | | 1155600 | 1155600 |
| | AB | 352800 | 78750 | 431550 | 100800 | 472500 | 573300 |
| | B | 675720 | 34650 | 710370 | 174480 | 818100 | 992580 |
| | BC | 403200 | 0 | 403200 | 100800 | 472500 | 573300 |
| | C | 1104000 | 0 | 1104000 | 759840 | 537300 | 1297140 |
| | AD | 56640 | 429516 | 486156 | 28320 | 473796 | 502116 |
| | ABDE | 0 | 193725 | 193725 | 0 | 193725 | 193725 |
| | BE | 159890 | 85239 | 245129 | 0 | 335421 | 335421 |
| | BCEF | 123900 | 0 | 123900 | 0 | 193725 | 193725 |
| | CF | 339250 | 0 | 339250 | 198240 | 220293 | 418533 |
| | D | 598296 | | 598296 | 284064 | | 284064 |
| | DE | 191520 | 294525 | 486045 | 80640 | 467775 | 548415 |
| | E | 574870 | 129591 | 704461 | 139584 | 809919 | 949503 |
| | EF | 380100 | 0 | 380100 | 80640 | 467775 | 548415 |
| | F | 1040750 | 0 | 1040750 | 699936 | 531927 | 1231863 |
| Broad- | Total pixels | 6000936 | 1420596 | 7421532 | 2647344 | 7150356 | 9797700 |
| cast | Mbyte | 9.00 | 2.13 | 11.13 | 3.97 | 10.73 | 14.70 |
| | Gbit/s | 4.32 | 1.02 | 5.34 | 1.91 | 5.15 | 7.05 |
| Point- | Total pixels | 7846596 | 1972035 | 9818631 | 3107664 | 10087470 | 13195134 |
| to- | Mbyte | 11.77 | 2.96 | 14.73 | 4.66 | 15.13 | 19.79 |
| point | Gbit/s | 5.65 | 1.42 | 7.07 | 2.24 | 7.26 | 9.50 |

1. A method of processing an original image for projection on a projection screen by a projector, comprising performing pixel interpolation between pixels of a first image associated with the original image and pixels of a second image associated with a pixel grid of the projector, wherein at least one of the first image and the second image has a pixel resolution greater than the resolution of, respectively, the original image and the pixel grid.

2. A method according to claim 1, further comprising upscaling the original image for obtaining the first image, thereby leading to a pixel resolution of the first image greater than the pixel resolution of the original image.

3. A method according to claim 2, wherein the original image is upscaled according to an upscale factor determined in order to reduce a difference between a first pixel density of the obtained first image and a second pixel density of the second image.

4. A method according to claim 3, wherein the original image is upscaled to said second pixel density.

5. A method according to claim 3, wherein the second pixel density of the second image is chosen to be substantially equal to said first pixel density.

6. A method according to claim 2, wherein the original image is upscaled according to an upscale factor determined according to a zoom command.

7. A method according to claim 6, wherein, when receiving a zoom in command, a current upscale factor, used for the upscaling, is increased.

8. A method according to claim 6, wherein when receiving a zoom out command, a current upscale factor, used for the upscaling, is decreased.

9. A method according to claim 1, wherein the second image has a pixel resolution greater than the resolution of the pixel grid and wherein the method further comprising downscaling the second image after performing pixel interpolation between the first image and the second image to the resolution of the pixel grid.

10. A method according to claim 1, wherein at least one of the upscaling and the downscaling is performed in a frequency domain.

11. A method according to claim 1, wherein the pixel interpolation is at least one of
a nearest-neighbour interpolation,
a bi-cubic interpolation, and
a bi-linear interpolation.

12. A method according to claim 9, wherein said second image is downscaled according to a downscale factor determined according to a zoom command.

13. A method according to claim 12, wherein when receiving a zoom in command, a current downscale factor used for downscaling the second image obtained after performing the pixel interpolation is decreased.

14. A method according to claim 12, wherein when receiving a zoom out command, a current downscale factor used for downscaling the second image obtained after performing the pixel interpolation is increased.

15. A method of processing an original image for projection on a projection screen by a plurality of projectors, comprising the following steps:
dividing said original image into image portions, each image portion being intended to be projected on the projection screen by a respective projector, and
processing each image portion according to claim 1.

16. A method according to claim 15, further comprising upscaling the image portions for obtaining the respective first images, thereby leading to a pixel resolution of the first images greater than the pixel resolution of the respective image portions, and a step of blending the image portions after upscaling.

17. An image processing device for processing an original image for projection on a projection screen by a projector, comprising a control unit configured to perform pixel interpolation between pixels of a first image associated with the original image and pixels of a second image associated with a pixel grid of the projector, wherein at least one of the first image and the second image has a pixel resolution greater than the resolution of, respectively, the original image and the pixel grid.

18. A device according to claim 17, wherein the control unit is further configured to upscale the original image for obtaining the first image, thereby leading to a pixel resolution of the first image greater than the pixel resolution of the original image.

19. A device according to claim 18, wherein the original image is upscaled according to an upscale factor determined in order to reduce a difference between a first pixel density of the obtained first image and a second pixel density of the second image.

20. A device according to claim 19, wherein the original image is upscaled to said second pixel density.

21. A device according to claim 19, wherein the second pixel density of the second image is chosen to be substantially equal to said first pixel density.

22. A device according to claim 19, wherein the original image is upscaled according to an upscale factor determined according to a zoom command.

23. A device according to claim 22, wherein the control unit is further configured for increasing a current upscale factor used for the upscaling, when receiving a zoom in command.

24. A device according to claim 22, wherein the control unit is further configured to decrease a current upscale factor used for the upscaling when receiving a zoom out command.

25. A device according to claim 17, wherein the second image has a pixel resolution greater than the resolution of the pixel grid and wherein the control unit is further configured to downscale the second image after performing pixel interpolation between the first image and the second image to the resolution of the pixel grid.

26. A device according to claim 17, wherein at least one of the upscaling and the downscaling is performed in a frequency domain.

27. A device according to claim 17, wherein the pixel interpolation is at least one of:
a nearest-neighbour interpolation,
a bi-cubic interpolation, and
a bi-linear interpolation.

28. A device according to claim 25, wherein said second image is downscaled according to a downscale factor determined according to a zoom command.

29. A device according to claim 28, wherein the control unit is further configured for decreasing a current downscale factor used for downscaling the second image obtained after performing the pixel interpolation when receiving a zoom in command.

30. A device according to claim 28, wherein the control unit is further configured to increase a current downscale factor used for downscaling the second image obtained after performing the pixel interpolation when receiving a zoom out command.

31. An image processing device for processing an original image for projection on a projection screen by a plurality of projectors, according to claim 17, wherein the control unit is further configured to divide said original image into image portions, each image portion being intended to be projected on the projection screen by a respective projector, and for at least one image portion, to perform pixel interpolation between pixels of a first image associated with the image portion and a second image associated with a pixel grid of the respective projector, wherein at least one of the first image and the second image has a pixel resolution greater than the resolution of, respectively, the image portion and the pixel grid.

32. A device according to claim 31, wherein the control unit is further configured to perform blending on the at least one image data portion after upscaling.

33. A video projection system comprising:
at least one device according to claim 17, and
at least one projector for projecting images processed by the device on a projection screen.

34. A system according to claim 33, wherein the at least one projector embeds the control unit of said device.

35. A non-transitory information storage means readable by a computer or a microprocessor storing instructions of a computer program, wherein the instructions of the computer program for implementing a method according to claim 1 when the program is loaded and executed by the computer or the microprocessor.

36. A method of processing image data for projection on a projection screen by a plurality of projectors projecting respective image portions of an image, the method comprising the following steps:
receiving a first command associated with a modification of at least one portion of said image, and
transmitting a second command for synchronous action to a first set of control units, based on the first command, said second command enabling said first set of control units to synchronously perform at least one action, by at least one projector of the plurality, in order to carry out said modification.

37. A method according to claim 36, further comprising determining, according to said modification, at least one projection parameter for said at least one image portion of the image, and wherein said action comprises a projection configuration based on said at least one projection determined parameter.

38. A method according to claim 37, further comprising transmitting said at least one determined parameter to said first set of control units.

39. A method according to claim 38, further comprising determining said first set of control units by determining projectors whose projection is affected by said determined parameter.

40. A method according to claim 36, wherein said first command originates from a user.

41. A method according to claim 36, wherein said first command is a forwarded command.

42. A method according to claim 36, wherein said synchronous configuration is based on an event detectable by said first set of control units.

43. A method according to claim 42, wherein said event is indicated in said second command.

44. A method according to claim 42, wherein said event takes into account a type of processing needed for the configuration of the projection, by at least one projector of the plurality, of said at least one portion of the image, according to said modification.

45. A method according to claim 42, wherein said event takes into account a transmission delay for transmission of said second command.

46. A method according to claim 42, wherein said event is a time-based event.

47. A method according to claim 42, wherein said event is a video frame-based event.

48. A method according to claim 36, wherein said second command is transmitted by encapsulation into a video frame.

49. A method according to claim 47, wherein the event is associated with a number of video frames starting from the video frame comprising the second command.

50. A method according to claim 36, further comprising performing at least one action, in order to carry out said modification, in synchronization with the set of control units.

51. A method according to claim 36, further comprising:
receiving at least one third command for synchronous action, for synchronously perform at least one action, by at least one projector of the plurality, in order to carry out the same modification as the modification associated with the first command, and
performing at least one action, in order to carry out said modification, in synchronization with the set of control units based on a synchronization element selected among synchronization elements respectively associated with said second and at least one third command.

52. A method according to claim 51, wherein said synchronization elements are associated with respective event, and wherein the selected synchronization element is the one associated with the event occurring the latest.

53. A method according to claim 42, further comprising monitoring said event.

54. A method according to claim 36, further comprising a step of preparation of said at least one action.

55. A method according to claim 54 wherein said step of preparation of said at least one action is performed after checking whether said preparation is needed, based on the modification associated with the first command.

56. A method according to claim 54, wherein said step of preparation of said at least one action is performed based on external information relating to at least one another control unit of another projector of the system.

57. A method according to claim 56, wherein said external information is obtained from said at least one another control unit of another projector of the system or by performing calculations.

58. A method according to claim 55, wherein said external information is obtained after checking whether said external information is needed, based on the modification associated with the first command.

59. A method according to claim 36, wherein said first command comprises at least one of:
a digital zoom;
an optical zoom;
an image shifting;
a brightness control;
a colour control.

60. A method according to claim 36, further comprising determining, according to said modification, at least one projection parameter for said at least one image portion of the image, and wherein said action comprises a projection configuration based on said at least one projection determined parameter, and wherein said at least one projection parameter comprises at least one of:
a rescaling parameter,
an image cut parameter;
an image data routing parameter;
an upscaling parameter;
a downscaling parameter;
an interpolation parameter.

61. A device for processing image data for projection on a projection screen by a plurality of projectors projecting respective image portions of an image, the device comprising a control unit configured for receiving a first command associated with a modification of at least one portion of said image, and for transmitting a second command for synchronous action to a first set of control units, based on the first command, said second command enabling said first set of control units to synchronously perform at least one action, by at least one projector of the plurality, in order to carry out said modification.

62. A video projection system comprising:
at least one device according to claim 61, and
at least one projector for projecting images processed by the device on a projection screen.

63. A system according to claim 62, wherein the at least one projector embeds the control unit of said device.

64. A system according to claim 62 further comprising a remote control for issuing the first command.

65. A system according to claim 62, further comprising a device configured for receiving said second command and synchronously executing said at least one action.

66. A system according to claim 65, wherein at least one projector embeds the control unit of said device configured for receiving said second command and synchronously executing said at least one action.

67. A non-transitory information storage means readable by a computer or a microprocessor storing instructions of a computer program, for implementing a method according to claim 36 when the program is loaded and executed by the computer or microprocessor.
